(19) United States
(12) Patent Application Publication
(10) Pub. No.: US 2024/0175445 A1
(43) Pub. Date: May 30, 2024

(54) PUMP MOTOR UNIT COMPRISING AN INTEGRATED COOLING SYSTEM FOR AN ELECTRONICS COMPONENT

(71) Applicant: Schwäbische Hüttenwerke Automotive GmbH, Aalen (DE)

(72) Inventor: Dominik Baur, Scheer (DE)

(21) Appl. No.: 18/511,010

(22) Filed: Nov. 16, 2023

(30) Foreign Application Priority Data
Nov. 25, 2022 (DE) 10 2022 131 277.1

(51) Int. Cl. F04D 29/58; F04D 13/06; F04D 29/08

(52) U.S. Cl. CPC F04D 29/5813; F04D 13/06; F04D 29/086; F04D 1/00

(57) ABSTRACT

A pump-motor unit includes: a housing with a motor space, an electronics space and a pump space; an impeller; an electric drive motor for the impeller; and an electronics component. The housing includes: a circumferential wall surrounding the drive motor; a cooling structure arranged axially between the motor space and the electronics space; and an annular cooling channel connected to a higher-pressure pump space region and to a lower-pressure pump space region, in order to channel fluid from the higher-pressure pump space region to the lower-pressure pump space region via the cooling channel in order to cool the electronics component. The cooling structure is joined to the circumferential wall of the housing, with which it forms a joining gap around a longitudinal axis of the circumferential.

### CROSS REFERENCE TO RELATED APPLICATIONS

This application claims benefit of priority to German Patent Application No. 10 2022 131 277.1, filed Nov. 25, 2022. The contents of this application are incorporated herein by reference.

### FIELD OF THE INVENTION

The invention relates to a pump-motor unit for delivering a fluid, a sub-flow of which is diverted within the pump-motor unit in order to cool an electronic component of the unit. The invention relates in particular to a pump-motor unit in which a coolant pump for delivering a coolant, preferably a liquid coolant, and a motor for driving the pump are arranged in a common housing. As a coolant pump, the unit can in particular be configured for delivering a water-based cooling liquid. The electronics component can in particular be a constituent part of an electronic controller and/or regulator for the drive motor, wherein at least the electronics component of the controller and/or regulator to be cooled is arranged in the common housing. Expediently, the entire controller and/or regulator is arranged in the common housing. One preferred area of application is in automotive engineering, in which the pump-motor unit can for example be used to deliver a liquid coolant for cooling an internal combustion engine or for cooling a battery system or fuel cell of an electric drive motor or, in hybrid vehicles, for cooling both drive systems.

### BACKGROUND OF THE INVENTION

A pump, a drive motor for the pump and a controller for the drive motor are often combined compactly in a common housing in coolant pumps. In order to cool power-electronic components of the controller, a sub-flow of the coolant delivered by such a pump-motor unit is diverted in the housing into a high-pressure region of the pump and channelled through a cooling structure in order to cool the cooling structure and therefore the electronic components. After flowing through the cooling structure, the coolant is guided back into a low-pressure region of the pump, such that a closed cooling circulation which is internal to the pump-motor unit is obtained. The invention relates in particular to such pump-motor units exhibiting an integrated cooling circulation.

EP 0 831 236 B2, incorporated herein by reference, for example proposes forming the cooling structure by means of a cooling plate in which a channel extends which the diverted coolant flows through in order to cool the cooling plate and thus the electronic components. How the cooling channel is produced in the cooling plate is not described.

DE 10 2018 126 775 A1, incorporated herein by reference, discloses a pump-motor unit comprising a two-part cooling structure. The cooling structure comprises a plate featuring a cooling channel which extends sinuously on a front-facing side which faces axially away from the motor and towards a controller. The cooling structure therefore also comprises a covering plate which covers the sinuous cooling channel on the front-facing side and which is in cooling contact with the electronics components of the controller. The coolant guided through the cooling channel therefore cools the covering plate and thus the electronics.

A cooling structure for electronic components of a pump-motor unit is likewise known from U.S. Pat. No. 9,618,011 B2, incorporated herein by reference. This cooling structure is also plate-shaped and consists of multiple parts. It comprises a central fluid space and transversely drilled feed lines and drainage lines in which the fluid used for cooling is guided from the high-pressure region of the pump to the central fluid space and from the central fluid space to the low-pressure region. The fluid space is closed off from the motor by a cover element.

The integrated cooling systems known from the prior art for the respective power electronics require additional component parts, such as for example a covering plate for covering a cooling channel which is open on the front-facing side, or require the drilling of transverse channels to a central fluid space, wherein the fluid space in the housing and the transverse channels on the outside of the housing have to be closed off, or the prior art does not describe how the cooling channel is produced in the cooling plate.

### SUMMARY OF THE INVENTION

It is therefore an aspect of the invention to provide a pump-motor unit comprising an integrated cooling system, which is simple in design but nonetheless effective, for an electronic component of the unit.

The invention relates to a pump-motor unit comprising a housing which features a pump space, a motor space and an electronics space. The pump space comprises a lower-pressure pump space region having a fluid inlet and a higher-pressure pump space region having a fluid outlet for a fluid to be delivered by the unit. The pump-motor unit comprises: an impeller which is arranged in the pump space such that it can be rotated about a rotational axis of the pump; and an electric drive motor for the impeller which is arranged in the motor space. The drive motor comprises: a stator; and a rotor which can be rotated about a rotational axis of the motor and which is coupled to the impeller in order to rotationally drive it. When the impeller is rotationally driven, the fluid is suctioned in at the fluid inlet, flows through the pump space and is expelled at an increased pressure at the fluid outlet.

The pump-motor unit also comprises at least one electronics component which is arranged in the electronics space. An electronic controller for the drive motor of the unit comprising the corresponding electronics components is expediently arranged in the electronics space of the housing. The term “controller” is intended to encompass a controller in the narrower sense, i.e. a simple controller with no feedback of a regulating variable, as well as a regulator for the drive motor.

The housing comprises: a circumferential wall which surrounds the drive motor; a cooling structure; and a cooling channel for cooling the one or optionally multiple electronics components which is/are arranged in the electronics space. The cooling channel comprises a cooling channel inlet connected to the higher-pressure pump space region and a cooling channel outlet connected to the lower-pressure pump space region. For the purpose of cooling, a sub-flow of the fluid delivered by the pump-motor unit is diverted in the higher-pressure pump space region and guided to the cooling channel inlet as an internal cooling flow. The diverted fluid flows through the cooling channel and is guided back into the lower-pressure pump space region via the cooling channel outlet. The pressure difference between the higher-pressure pump space region and the lower-pressure pump space region ensures that the fluid flows through the cooling channel.

Within a first aspect of the invention (the aspect of simplifying the design of the integrated cooling system), the cooling structure is formed separately from the circumferential wall of the housing and is joined to the circumferential wall of the housing, for example by means of a screw connection. The cooling structure, and the circumferential wall of the housing which surrounds the motor space, together form a joining gap which extends around a central longitudinal axis of the circumferential wall of the housing. In accordance with the invention, the cooling channel is annular and extends and is sealed off around the longitudinal axis in the region of the joining gap. Forming the cooling channel in the joining gap between the circumferential wall of the housing and the cooling structure simplifies the design and assembly of components of the integrated cooling circulation and reduces the installation space required in order to produce the cooling channel. It is then for example unnecessary to additionally provide and assemble a component part in order to close the cooling channel.

In advantageous embodiments, the cooling channel is closed by joining the joining structures, i.e. joining the cooling structure to the circumferential wall of the housing. If one or more gaskets are provided for sealing off the cooling channel, it/they can be assembled on the circumferential wall of the housing or on the cooling structure, or one gasket can be assembled on the circumferential wall of the housing and another can be assembled on the cooling structure in a preceding assembly step, such that the cooling channel is also already sealed off by joining the cooling structure and the circumferential wall of the housing.

The cooling structure can be joined from multiple separately produced sub-structures. It is however more advantageous for the cooling structure to not be joined from sub-structures but to rather be a structure which is formed in one part and which is in this sense a monolithic structure. It can be formed in one piece in an original-moulding method, for example as a casting, which does not exclude the possibility of subsequent processing, such as for example machining. The cooling structure is preferably a metal structure, such as for example a cast metal structure.

In order to form the cooling channel, one of the joining structures which are joined to each other, i.e. the circumferential wall of the housing or the cooling structure, can comprise a recess on a joining surface which is situated in the joining gap. The other joining structure overlaps this joining surface and therefore also overlaps the recess. In order to form the cooling channel, it is also possible for each of the two joining structures to comprise a recess in the joining gap, wherein the two recesses at least partially overlap each other in the joining gap and can thus form the cooling channel together when the joining structures are joined.

The cooling channel can also be sealed off laterally in a simple way in the joining gap. It can for example be sealed off by providing an appropriate fit between the joining structures. More preferably, however, the cooling channel is sealed off by means of a gasket arranged in the joining gap.

The gasket can consist of one part and comprise two sealing rings or sealing lips which adjacently protrude from a base body of the gasket, such that for example a U-shaped or V-shaped gasket profile is obtained overall. A recess is obtained between the sealing rings or sealing lips which, when the joining structures are joined, is open towards the cooling structure and forms the cooling channel. In the joining gap, the two sealing rings or sealing lips rest against a joining surface of the cooling structure in a sealing contact in each case. In such embodiments, a recess in the circumferential wall of the housing and/or in the cooling structure is not required.

Preferably, however, the gasket consists of multiple parts and comprises a first gasket element, which seals off the joining gap on one side of the cooling channel, and a second gasket element which is separate from the first gasket element and which seals off the joining gap on the other side of the cooling channel.

The cooling channel inlet and the cooling channel outlet can lie radially outside an enclosing circular cylinder which envelops the drive motor, wherein the longitudinal axis of the circumferential wall of the housing can simultaneously be the central longitudinal axis of the virtual enclosing circular cylinder. The pump-motor unit comprises a feed channel, which connects the cooling channel to the higher-pressure pump space region and emerges into the cooling channel inlet, and a return channel which connects the cooling channel to the lower-pressure pump space region and adjoins the cooling channel outlet in the flow direction, i.e. emerges into the cooling channel outlet. In preferred embodiments, the feed channel extends up to the cooling channel inlet, and the return channel extends up to the cooling channel outlet, peripherally from the drive motor through the circumferential wall of the housing. Cooling the one or more electronics components does not therefore require any particular design features for the drive motor, which can be embodied and arranged in the housing without any restrictions due to the integrated cooling system.

In preferred embodiments, the cooling channel extends radially outside the virtual enclosing circular cylinder over at least most of its length. It is advantageous for the cooling channel to extend radially outside the enclosing circular cylinder over its entire profile. It is thus possible to provide a long cooling section, exhibiting a correspondingly high cooling capacity, even using a merely annular cooling channel, wherein a cooling channel which extends outside the enclosing circular cylinder can advantageously be implemented in combination with a cooling channel inlet which lies outside the enclosing circular cylinder and a cooling channel outlet which lies outside the enclosing circular cylinder.

In the interests of a high cooling capacity, it is advantageous for the cooling channel to extend from the cooling channel inlet up to the cooling channel outlet over an arc angle of at least 270° around the longitudinal axis of the circumferential wall of the housing. In advantageous embodiments, the cooling channel extends from the cooling channel inlet towards the cooling channel outlet in one circumferential and/or flow direction only, such that the flow in the cooling channel is not divided and does not flow along different flow paths to the cooling channel outlet, but rather the fluid flows through the cooling channel in one circumferential and/or flow direction only. The cooling channel can extend spirally in the joining gap over an arc angle of more than 360º, but more preferably extends over an arc angle of less than 360º only and thus in only one cooling channel loop around the longitudinal axis of the circumferential wall of the housing. In preferred embodiments, the cooling channel inlet and the cooling channel outlet are separated about the longitudinal axis by an arc angle of at most 90° or at most 60º. Conversely, in advantageous embodiments, they exhibit a distance from each other in the circumferential direction around the longitudinal axis which is large enough to ensure fluidic separation in the joining gap over this distance, wherein the cooling channel inlet and the cooling channel outlet can exhibit a distance from each other, in particular in the circumferential direction, in the joining gap.

The cooling channel can extend sinuously around the longitudinal axis of the circumferential wall of the housing in the joining gap, but producing it would then be associated with additional cost and/or effort. The flow resistance would also be increased. It is therefore more advantageous for the cooling channel to not also be curved around one or more other axes in addition to its curvature around the longitudinal axis of the circumferential wall of the housing as imposed by the encircling joining gap.

The joining gap can be a purely axial joining gap, i.e. a joining gap formed exclusively by one or more front-facing surfaces of the circumferential wall of the housing and one or more front-facing surfaces of the cooling structure, in that the one or more front-facing surfaces of the circumferential wall of the housing and the one or more front-facing surfaces of the cooling structure face axially opposite each other across the joining gap. The circumferential wall of the housing and the cooling structure can rest axially against each other in contact in the axial joining gap. Alternatively, the joining gap can have a clear but small axial gap width. Each of the two sides of the cooling channel can be sealed off by means of an axial gasket arranged in the overlapping front-facing wall region, for example by means of a radially outer axial gasket ring and a radially inner axial gasket ring.

In alternative embodiments, the joining gap can be a purely radial joining gap, in that one or more circumferential surfaces of the circumferential wall of the housing and one or more circumferential surfaces of the cooling structure face radially opposite each other. The circumferential wall of the housing and the cooling structure can rest radially against each other in contact in the radial joining gap. Alternatively, the joining gap can have a clear but small radial gap width. Each of the two sides of the cooling channel can be sealed off by means of a radial gasket arranged in the overlapping circumferential wall region, for example by means of a right-hand radial gasket ring and a left-hand radial gasket ring.

In preferred embodiments, the joining gap extends both in the axial direction, i.e. in the direction of the longitudinal axis of the housing, and radially with respect to the longitudinal axis of the housing and, in such embodiments, comprises a radial joining gap portion obtained in the axial overlap and an axial joining gap portion obtained in the radial overlap. When the joining gap extends “around the corner” in this way, the cooling channel can advantageously be sealed off on one side by means of a radial gasket arranged in the overlapping circumferential wall region, for example in the form of a radial gasket ring, and on the other side by means of an axial gasket arranged in the overlapping front-facing wall region, for example in the form of an axial gasket ring.

The cooling channel itself can for example extend in an overlapping front-facing wall region, i.e. in an axial joining gap or joining gap portion, only or in an overlapping circumferential wall region, i.e. in a radial joining gap or joining gap portion, only. In embodiments in which the joining gap extends “around the corner”, the cooling channel can be crimped, i.e. can likewise extend “around the corner”. If, in a joining gap which extends “around the corner”, the cooling structure encompasses the circumferential wall of the housing, the encompassed region of the circumferential wall of the housing can also be simply bevelled or incrementally recessed at its front-facing end situated in the joining gap, in order to form the cooling channel.

The housing comprises: a pump space portion which delimits and can in particular surround the pump space and therefore also the impeller; a motor space portion which surrounds the motor space and therefore also the drive motor; and an electronics space portion which delimits and can in particular surround the electronics component and as applicable other electronics components, for example a controller for the motor. The drive motor can be embodied and operated as a wet rotor or a dry rotor. The integrated cooling system for the electronics component and as applicable other electronics components is in particular advantageous for embodiments as a dry rotor.

The cooling structure can for example be a ring structure which extends axially between the motor space and the electronics space and which can axially overlap with the motor space and/or electronics space. In preferred embodiments, the cooling structure comprises a front-facing wall. It can even be formed as a simple front-facing wall. It can close off the motor space on one front-facing side and separate it from the electronics space, although connecting conduits for supplying the drive motor with electrical energy and/or control signals can be guided through the front-facing wall. In an advantageous embodiment, however, such a cooling structure largely prevents abrasion and/or liquid from being able to pass into the electronics space from the motor space.

As mentioned, preferred embodiments of the cooling structure comprise a front-facing wall which can be used as a support structure for the one or more electronics components to be cooled. The one or more electronics components are expediently arranged on the front-facing wall of the cooling structure, i.e. on the rear side of the front-facing wall of the cooling structure which faces away from the motor space, via a thermally highly conductive material, for example a thermally conductive pad. The cooling structure can in particular comprise a front-facing wall featuring an axial projection, for example in the form of a circumferential wall of the cooling structure which protrudes axially from the front-facing wall of the cooling structure. The front-facing wall of the cooling structure can then form an axial joining gap or joining gap portion with the circumferential wall of the housing and/or the circumferential wall of the cooling structure can then form a radial joining gap or joining gap portion with the circumferential wall of the housing.

The circumferential wall of the housing can form the motor space portion of the housing and can extend over its entire length. The circumferential wall of the housing extends over at least most of the axial length of the motor space portion. The cooling structure can form a motor space cover by closing off the circumferential wall of the housing on the front-facing side. In such embodiments, the circumferential wall of the housing terminates axially at the motor space and comprises a motor space opening, which is closed off by the cooling structure, at the relevant front-facing end. In such embodiments, the housing comprises another housing structure which surrounds the electronics space. Said other housing structure can be joined directly to the cooling structure only or to the circumferential wall of the housing, which surrounds the motor space, via the cooling structure. Said other housing structure can however in principle also be joined directly to the circumferential wall of the housing, bypassing the cooling structure.

In variants, the circumferential wall of the housing can however also extend axially beyond the motor space and surround an axial sub-portion of the electronics space or also the electronics space over its entire axial length if, as is preferred, the electronics space is an axial extension of the motor space. In these variants, the cooling structure can be inserted into the circumferential wall of the housing up to and into an intended axial joining position, via an electronics space opening on the front-facing side of the circumferential wall of the housing, and joined to the circumferential wall of the housing in the joining position.

The impeller can be a toothed wheel of a toothed wheel pump or in principle also a vaned wheel of a vane pump. Preferably, however, the impeller is radially designed, i.e. embodied as a radial impeller. The impeller can be rotated in the pump space about a rotational axis of the pump. When an impeller which is embodied as a radial impeller is rotationally driven, the fluid to be delivered is suctioned axially in relation to the rotational axis of the pump on a suction side of the impeller, deflected in the radial direction, delivered to the fluid outlet over the circumference of the impeller and discharged through the fluid outlet. In such embodiments, the pump space can exhibit a circumference which surrounds the impeller in a spiral shape, starting from a free tongue tip of a spiral tongue, as is known from centrifugal pumps. The fluid outlet adjoins the spiral-shaped circumference in the delivery direction and can in particular extend in a direction which is tangential to the rotational axis of the pump, in order to correspondingly deliver the fluid tangentially out of the pump space.

If the impeller is embodied as a radial impeller comprising delivery paddles, it can comprise a covering structure on a suction side which faces the fluid inlet, wherein the covering structure overlaps the delivery paddles and forms a suction-side clearance with the housing. The clearance is used to seal off and thus separate the higher-pressure pump space region from the lower-pressure pump space region. In advantageous embodiments, the covering structure comprises a circumferential wall which extends axially with respect to the rotational axis of the pump and/or a front-facing wall which extends radially and in the circumferential direction. The covering structure can in particular comprise an axially extending circumferential wall and a radially extending front-facing wall. The circumferential wall can extend axially up to the fluid inlet. The front-facing wall can advantageously adjoin the circumferential wall in the direction of the higher-pressure pump space region.

In low-output radial delivery pumps and equally when operating radial delivery pumps in their lower partial load range, friction losses in the rotational mounting of the impeller have a significant influence on the effectiveness of the pump. Conversely, particularly high demands are placed on the energy efficiency of auxiliary units, such as for example a coolant pump, in vehicle engineering (a preferred area of application for the invention). For the purposes of designing the pump, it follows that friction diameters should be kept as small as possible, since the friction loss increases significantly with friction diameter. It follows that the diameters of bearings, gaskets and therefore also shafts are advantageously as small as possible. However, they have to be mounted and sealed off in a way which withstands the mechanical stresses throughout their service life. Axial forces and radial forces which act on the impeller are known to represent a substantial load on the one or more bearings of the drive shaft in radially designed centrifugal pumps.

It is therefore another object of the invention to reduce the mechanical stress on mounting the impeller and/or sealing off the bearings.

Within a second aspect of the invention (the aspect of relieving the bearings), the invention relates to a pump-motor unit comprising: a housing which features a motor space, an electronics space and a pump space; and an impeller which is arranged in the pump space such that it can be rotated about a rotational axis of the pump in order to deliver a fluid from a fluid inlet of the pump space to a fluid outlet of the pump space. The impeller is radially designed. The pump space forms a collecting space having a circumference which extends in a spiral shape around the impeller from a tongue tip of a spiral tongue. The pump-motor unit also comprises an electric drive motor which is arranged in the motor space and comprises a stator and a rotor which can be rotated about a rotational axis of the motor and which is coupled to the impeller in order to rotationally drive the impeller. At least one electronics component is arranged in the electronics space as another constituent part of the pump-motor unit. With regard to the electronics component, reference is made to the statements already made with respect to the first aspect.

Within the aspect of relieving the bearings, the pump-motor unit again comprises a cooling channel which is connected to the higher-pressure pump space region and the lower-pressure pump space region, as already described above, in order to divert some of the fluid delivered by the impeller from the higher-pressure pump space region and guide it through the cooling channel in order to cool the electronics component and/or drive motor. Another constituent part of the pump-motor unit is the return channel which connects the cooling channel to the lower-pressure pump space region and terminates in the lower-pressure pump space region at a return opening in the housing.

The radially designed impeller comprises delivery paddles and, on a suction side which axially faces the fluid inlet, a covering structure which overlaps the delivery paddles and forms a suction-side clearance with the housing. The statements already made above within the first aspect also apply in this respect.

In accordance with the second aspect of the invention, the return opening lies opposite the covering structure of the impeller in the clearance for the purpose of relieving the bearings, such that the fluid which flows back through the return channel and its return opening exerts an axial force and/or a radial force on the impeller in the clearance. If the fluid which flows back exerts an axial force on the covering structure and therefore on the impeller and its rotational mounting, this axial force acts in the suction direction in which the fluid flows towards the impeller on the suction side of the impeller, i.e. at the fluid inlet. This can compensate for at least some of the axial force which acts counter to the suction direction due to delivery operations. If the fluid which flows back from the cooling channel exerts a radial force on the covering structure and therefore on the impeller and its rotational mounting in the clearance, this radial force preferably acts in the direction of the hemisphere of the pump space in which the fluid outlet is located, as viewed in an axial top view onto the impeller. The pressure is higher in the region of the fluid outlet when the pump is in operation. The fluid outlet is to be assigned to the higher-pressure pump space region, such that radial forces act radially from the fluid outlet towards the impeller, as viewed in the top view, and are at least partially compensated for by the radial force which is generated in accordance with the invention by means of the fluid which flows back from the cooling channel, wherein the covering structure can be shaped and the return opening arranged and aligned such that both an axial force and a radial force are exerted on the covering structure and therefore on the impeller for the purpose of compensating.

The covering structure can comprise a circumferential wall which extends axially with respect to the rotational axis of the pump and/or a front-facing wall which extends radially and in the circumferential direction. If the covering structure comprises the circumferential wall, the return opening can lie radially opposite this circumferential wall, such that the fluid which flows back from the cooling channel is guided at least substantially in the radial direction and/or primarily against the circumferential wall of the covering structure via the return opening. If the covering structure comprises the front-facing wall, the return opening can lie axially opposite this front-facing wall and the fluid which flows back from the cooling channel can be directed at least substantially in the axial direction against the front-facing wall of the covering structure. Depending on how the covering structure is embodied and the position and alignment of the return opening, it is possible to generate either an at least mostly axial compensating force or an at least mostly radial compensating force. The ratios can also be selected such that the compensating force is composed of axial and radial force components which are at least substantially identical in size.

In developments, the housing can exhibit a widening in the region of the clearance which radially and/or axially widens the clearance and extends in the circumferential direction over an arc angle of less than 360º or less than 180º around the covering structure of the impeller. The arc angle can be at least 20° or at least 30°. The arc angle is advantageously at most 120° or at most 100°. The return opening expediently emerges into the widening. By means of the widening, the direction of the compensating force can be influenced largely independently of the position of the return opening. The axial and/or radial pressure on the covering structure in the circumferential direction, which is required in order to generate the compensating force, can also be distributed over a larger area of the covering structure.

The widening, if provided, and/or the return opening is/are advantageously distanced from the tongue tip of the spiral tongue in and counter to the rotational direction of the impeller over an arc angle of more than 60° or more than 90° each. If the fluid which flows back from the cooling channel exerts a radial compensating force on the covering structure of the impeller, this radial compensating force is then directed towards the hemisphere of the pump space in which the fluid outlet is situated.

The two aspects, i.e. the simplified design of the integrated cooling system and relieving the bearings by means of the fluid which flows back from the cooling channel, can be implemented separately from each other or advantageously in combination. The features disclosed with respect to one respective aspect can therefore also advantageously be implemented within the other aspect in each case.

Features of the invention are also described in the aspects formulated below. The aspects are formulated in the manner of claims and can substitute for them. Features disclosed in the aspects can also supplement and/or qualify the claims, indicate alternatives with respect to individual features and/or broaden claim features. Bracketed reference signs refer to example embodiments of the invention illustrated below in figures. They do not restrict the features described in the aspects to their literal sense as such, but do conversely indicate preferred ways of implementing the respective feature.

Aspect 1. A pump-motor unit, comprising:
1.1 a housing which features a motor space, an electronics space and a pump space having a fluid inlet (21) and a fluid outlet (22);
1.2 an impeller (1) which is rotatably arranged in the pump space in order to deliver a fluid from the fluid inlet (21) to the fluid outlet (22);
1.3 an electric drive motor (7, 8) which is arranged in the motor space and comprises a stator (7) and a rotatable rotor (8) for rotationally driving the impeller (1); and
1.4 an electronics component (41) which is arranged in the electronics space, wherein the housing comprises:
1.5 a circumferential wall (11) which extends around a longitudinal axis (R) of the housing and surrounds the drive motor (7, 8);
1.6 a cooling structure (30) which is arranged axially between the motor space and the electronics space; and
1.7 a cooling channel (33; 37; 38; 19) comprising a cooling channel inlet (34; 19a) connected to a higher-pressure pump space region and a cooling channel outlet (35; 19b) connected to a lower-pressure pump space region, in order to channel some of the fluid from the higher-pressure pump space region to the lower-pressure pump space region via the cooling channel (33; 37; 38; 19) in order to cool the electronics component (41).

Aspect 2. The pump-motor unit according to the preceding aspect, wherein the cooling structure (30) is joined to the circumferential wall (11) of the housing, with which the cooling structure (30) forms a joining gap (A; B; C) around the longitudinal axis (R), and wherein the cooling channel (33; 37; 38; 19) annularly extends and is sealed off around the longitudinal axis (R) in the region of the joining gap (A; B; C).

Aspect 3. The pump-motor unit according to the preceding aspect, wherein the cooling channel inlet (34; 19a) and the cooling channel outlet (35; 19b) lie radially outside an enclosing circular cylinder which envelops the drive motor (7, 8).

Aspect 4. The pump-motor unit according to any one of the preceding aspects, wherein the cooling channel (33; 37; 38; 19) extends radially outside an enclosing circular cylinder which envelops the drive motor (7, 8).

Aspect 5. The pump-motor unit according to any one of the preceding aspects, comprising a feed channel (14, 24), which connects the cooling channel (33; 37; 38; 19) to the higher-pressure pump space region and emerges into the cooling channel inlet (34: 19a), and a return channel (15, 25) which connects the cooling channel (33; 37; 38; 19) to the lower-pressure pump space region and adjoins the cooling channel outlet (35; 19b), wherein the feed channel (14, 24) and the return channel (15, 25) each extend up to the cooling channel (33; 37; 38; 19) peripherally from the drive motor (7, 8) through the circumferential wall (11) of the housing.

Aspect 6. The pump-motor unit according to any one of the preceding aspects in combination with Aspect 2, wherein the cooling channel (33; 37; 38; 19) extends from the cooling channel inlet (34; 19a) up to the cooling channel outlet (35; 19b) over an angle of at least 270° around the longitudinal axis (R) in the joining gap (A; B; C).

Aspect 7. The pump-motor unit according to any one of the preceding aspects in combination with Aspect 2, wherein the cooling channel (33; 37; 38; 19) extends from the cooling channel inlet (34; 19a) up to the cooling channel outlet (35; 19b) over an angle of less than 360º around the longitudinal axis (R) in the joining gap (A; B; C).

Aspect 8. The pump-motor unit according to any one of the preceding aspects, wherein the cooling channel (33; 37; 38; 19) is annular and extends from the cooling channel inlet (34; 19a) up to the cooling channel outlet (35; 19b) around the longitudinal axis (R) in one circumferential direction only.

Aspect 9. The pump-motor unit according to any one of the preceding aspects, wherein the cooling structure (30) comprises an axial recess on a front-facing side and/or a radial recess on a circumference, which forms at least part of the cooling channel (33; 37; 38).

Aspect 10. The pump-motor unit according to any one of the preceding aspects, wherein the circumferential wall (11) of the housing comprises an axial recess on a front-facing side and/or a radial recess on a circumference, which forms at least part of the cooling channel (19).

Aspect 11. The pump-motor unit according to any one of the preceding aspects in combination with Aspect 2, wherein
the circumferential wall (11) of the housing comprises a front-facing surface, and the front-facing surface of the circumferential wall of the housing radially overlaps with the cooling structure (30) in the joining gap (A; B),
the cooling channel (33; 38) extends axially between the circumferential wall (11) of the housing and the cooling structure (30) around the longitudinal axis (R) in the joining gap (A; B),
an outer sealing element (17) seals off the cooling channel (33; 38) on the radially outer side, and
an inner sealing element (18) seals off the cooling channel (33; 38) on the radially inner side.

Aspect 12. The pump-motor unit according to any one of the preceding aspects in combination with Aspect 2, wherein
the circumferential wall (11) of the housing axially overlaps with the cooling structure (30) in the joining gap (B; C),
the cooling channel (37; 38) extends radially between the circumferential wall (11) of the housing and the cooling structure (30) around the longitudinal axis (R) in the joining gap (B; C),
a left-hand sealing element (17) seals off the cooling channel (37; 38) on an axially left-hand side, and
a right-hand sealing element (18) seals off the cooling channel (37; 38) on an axially right-hand side.

Aspect 13. The pump-motor unit according to any one of the immediately preceding two aspects, wherein
the sealing elements (17, 18) are separate sealing rings,
one of the sealing elements (17, 18) is positioned in a first receptacle (16), and the other of the sealing elements is positioned in a second receptacle (36), and
the first receptacle (16) is formed on the circumferential wall (11) of the housing or on the cooling structure (30), and
the second receptacle (36) is formed on the circumferential wall (11) of the housing or on the cooling structure (30).

Aspect 14. The pump-motor unit according to Aspect 11 or Aspect 12, wherein
a single sealing ring forms the sealing elements,
the sealing ring is positioned in a receptacle, and
the receptacle is formed on the circumferential wall (11) of the housing or on the cooling structure (30).

Aspect 15. The pump-motor unit according to any one of the preceding aspects in combination with Aspect 2, wherein the joining gap (A) comprises a radial joining gap portion and an axial joining gap portion, and a recess in a circumferential wall which delimits the radial joining gap portion or a recess in a front-facing wall of the cooling structure (30) or circumferential wall (11) of the housing which delimits the axial joining gap portion forms the cooling channel (33; 38; 19).

Aspect 16. The pump-motor unit according to any one of the preceding aspects in combination with Aspect 2, wherein the joining gap (A) comprises a radial joining gap portion and an axial joining gap portion, and the cooling channel (38) extends around the corner into both joining gap portions.

Aspect 17. The pump-motor unit according to any one of the preceding aspects, wherein the cooling structure (30) comprises an axial projection (32; 32a) which surrounds the circumferential wall (11) of the housing or is surrounded by the circumferential wall (11) of the housing, wherein the circumferential wall (11) of the housing and the cooling structure (30) radially delimit a radial joining gap (A; C) which annularly encircles the axial projection (32; 32a) and/or the circumferential wall (11) of the housing, and wherein the cooling channel (37; 38) preferably extends in the radial joining gap (A; C).

Aspect 18. The pump-motor unit according to the preceding aspect, wherein an annular sealing element (18), preferably a sealing ring which acts as a radial gasket, seals off the radial joining gap (A; C), preferably from the motor space.

Aspect 19. The pump-motor unit according to the preceding aspect, wherein another annular sealing element (17), preferably a sealing ring which acts as a radial gasket, seals off the radial joining gap (C), preferably from the electronics space.

Aspect 20. The pump-motor unit according to any one of Aspects 1 to 18, wherein the circumferential wall (11) of the housing and the cooling structure (30) overlap each other in the axial direction and in the radial direction in relation to the longitudinal axis (R) in the joining gap (A), and the cooling channel (38) extends axially and radially into the joining gap (A).

Aspect 21. The pump-motor unit according to any one of the preceding aspects, wherein a front-facing surface of the circumferential wall (11) of the housing and a front-facing surface of the cooling structure (30) form an annular axial joining gap (A; B), and an annular sealing element (17), preferably a sealing ring which acts as an axial gasket, seals off the axial joining gap (A; B) around the longitudinal axis (R) on the radially outer side.

Aspect 22. The pump-motor unit according to Aspect 19 or a combination of Aspects 18 and 21, wherein the cooling channel (33; 37; 38; 19) extends between the sealing elements (17, 18) around the longitudinal axis (R) and is sealed off by means of the sealing elements (17, 18).

Aspect 23. The pump-motor unit according to any one of the preceding aspects, wherein the impeller (1) is a radial impeller which can be rotated about a rotational axis (R) of the pump, and the housing exhibits a circumference (28) which surrounds the impeller (1) in a spiral shape.

Aspect 24. The pump-motor unit according to any one of the preceding aspects, wherein the impeller (1) is a radial impeller which can be rotated about a rotational axis (R) of the pump and comprises paddles (2) and, on a suction side which faces the fluid inlet, a covering structure (3) which forms a suction-side clearance with the housing.

Aspect 25. The pump-motor unit according to the preceding aspect, wherein the covering structure (3) comprises a circumferential wall (4) which extends axially with respect to the rotational axis (R) of the pump and/or a front-facing wall (5) which extends radially and in the circumferential direction.

Aspect 26. The pump-motor unit according to any one of the preceding aspects, comprising a return channel (15, 25) which connects the cooling channel (33; 37; 38; 19) to the lower-pressure pump space region and terminates in the lower-pressure pump space region at a return opening (26), such that the fluid which is channelled back through the return opening (26) exerts an axial counterforce on the impeller (1), counter to an axial force which acts on the impeller (1) due to the fluid being delivered, and/or exerts a radial counterforce on the impeller (1), counter to a radial force which acts on the impeller (1) due to the fluid being delivered.

Aspect 27. The pump-motor unit according to any one of the preceding aspects, comprising a return channel (15, 25) which connects the cooling channel (33; 37; 38; 19) to the lower-pressure pump space region and terminates in the lower-pressure pump space region at a return opening (26) of the housing which is formed in a clearance which is radially and/or axially delimited by the impeller (1) and the housing.

Aspect 28. The pump-motor unit according to any one of the preceding aspects, comprising a return channel (15, 25) which connects the cooling channel (33; 37; 38; 19) to the lower-pressure pump space region and terminates in the lower-pressure pump space region at a return opening (26) of the housing which is formed in a clearance which extends around the longitudinal axis (R) and is delimited by the impeller (1) and the housing, wherein the fluid which is guided back exerts an axial force on a suction side of the impeller (1), preferably on a covering structure (3) of the impeller (1), in the clearance.

Aspect 29. The pump-motor unit according to any one of the preceding aspects, comprising a return channel (15, 25) which connects the cooling channel (33; 37; 38; 19) to the lower-pressure pump space region and terminates in the lower-pressure pump space region at a return opening (26) of the housing which is formed in a clearance which extends around the longitudinal axis (R) and is delimited by the impeller (1) and the housing, wherein the return opening (26) lies opposite a suction side of the impeller (1), preferably a covering structure (3) of the impeller (1), across the clearance, such that the fluid which is guided back into the clearance exerts an axial force in the clearance, the direction of which matches the flow direction of the fluid at the fluid inlet (21).

Aspect 30. The pump-motor unit according to any one of the immediately preceding four aspects, wherein the impeller (1) is shaped and/or the return opening (26) is formed in the clearance such that the fluid which flows back through the return opening (26) exerts a force, having an at least predominant axial component, on the impeller (1).

Aspect 31. The pump-motor unit according to any one of Aspects 26 to 29, wherein the impeller (1) is shaped and/or the return opening (26) is formed in the clearance such that the fluid which flows back through the return opening (26) exerts a force, having an at least predominant radial component, on the impeller (1).

Aspect 32. The pump-motor unit according to any one of the preceding aspects, comprising a return channel (15, 25) which connects the cooling channel (33; 37; 38; 19) to the lower-pressure pump space region and terminates in the lower-pressure pump space region at a return opening (26) of the housing which is formed in a clearance which is delimited by the impeller (1) and the housing, wherein the housing comprises a widening (27) in the region of the clearance, wherein the widening (27) extends in the circumferential direction over an arc angle (B) of at least 20° and at most 120° around the impeller (1) and radially and/or axially widens the clearance.

Aspect 33. The pump-motor unit according to any one of the preceding aspects in combination with any one of Aspects 24 and 25, comprising a connecting channel (25a) which leads through the housing from the higher-pressure pump space region to the clearance and emerges at a channel opening (26a) which faces axially and/or radially opposite the covering structure (3) of the impeller (1) across the clearance, such that fluid is channelled directly from the higher-pressure pump space region into the clearance in order to exert an axial force and/or a radial force on the impeller (1) in the clearance.

Aspect 34. The pump-motor unit according to the preceding aspect, wherein the housing comprises a widening (27) in the region of the clearance, wherein the widening (27) extends in the circumferential direction over an arc angle (B) of at least 20° and at most 120° around the impeller (1) and radially and/or axially widens the clearance, and wherein the connecting channel (25a) emerges into the widening (27).

Aspect 35. The pump-motor unit according to any one of Aspects 26 to 34, wherein
the impeller (1) is a radial impeller,
the housing comprises a collecting space having a circumference (28) which extends in a spiral shape around the impeller (1) from a free tongue tip of a spiral tongue (29), and
the widening (27), if provided, and/or the return opening (26) is/are distanced from the tongue tip in and counter to the rotational direction of the impeller (1) over an arc angle (a) of more than 60° or more than 90°.

Aspect 36. The pump-motor unit according to any one of Aspects 26 to 35 in combination with any one of Aspects 24 and 25, wherein the widening (27), if provided, and/or the return opening (26) face radially opposite the circumferential wall (4) of the covering structure (3) and/or axially opposite the front-facing wall (5) of the covering structure (3) in the clearance.

Aspect 37. The pump-motor unit according to any one of the preceding aspects, wherein
the impeller (1) is a radial impeller,
the housing comprises a collecting space having a circumference (28) which extends in a spiral shape around the impeller (1) from a free tongue tip of a spiral tongue (29),
the cooling channel (33; 37; 38; 19) is connected to the higher-pressure pump space region via a feed channel (14, 24), and
the feed channel (14, 24) emerges at a divergence opening (23) on the spiral-shaped circumference (28) of the collecting space in the higher-pressure pump space region.

Aspect 38. A pump-motor unit, comprising:
38.1 a housing which features a pump space having a fluid inlet (21) and a fluid outlet (22), a motor space and an electronics space;
38.2 a radially designed impeller (1) which is arranged in the pump space such that it can be rotated about a rotational axis (R) of the pump in order to deliver a fluid from the fluid inlet (21) to the fluid outlet (22);
38.3 a collecting space formed by the pump space and having a circumference (28) which extends in a spiral shape around the impeller (1) from a tongue tip of a spiral tongue (29),
38.4 an electric drive motor (7, 8) which is arranged in the motor space and comprises a stator (7) and a rotor (8) for rotationally driving the radial impeller (1),
38.5 an electronics component (41) which is arranged in the electronics space, and
38.6 a cooling channel (33; 37; 38; 19) which is connected to a higher-pressure pump space region and a lower-pressure pump space region, in order to divert some of the fluid delivered by the impeller (1) from the higher-pressure pump space region and guide it through the cooling channel (33; 37; 38; 19) in order to cool the electronics component (41) and/or drive motor (7, 8), and
38.7 a return channel (15, 25) which connects the cooling channel (33; 37; 38; 19) to the lower-pressure pump space region and terminates in the lower-pressure pump space region at a return opening (26) of the housing,
38.8 wherein the impeller (1) comprises delivery paddles and, on a suction side which axially faces the fluid inlet (21), a covering structure (3) which forms a suction-side clearance with the housing, and
38.9 the return opening (26) lies opposite the covering structure (3) in the clearance, such that the fluid which flows back through the return channel (15, 25) exerts an axial force and/or a radial force on the radial impeller (1) in the clearance.

Aspect 39. The pump-motor unit according to the preceding aspect, wherein the housing comprises a widening (27) in the region of the clearance, wherein the widening (27) extends in the circumferential direction over an arc angle (B) of at least 20° and at most 120° around the impeller (1) and radially and/or axially widens the clearance.

Aspect 40. The pump-motor unit according to any one of the immediately preceding two aspects, wherein the widening (27), if provided, and/or the return opening (26) is/are distanced from the tongue tip in and counter to the rotational direction of the impeller (1) over an arc angle (a) of more than 60° or more than 90°.

Aspect 41. The pump-motor unit according to any one of the immediately preceding three aspects, wherein the feed channel (14, 24) emerges at a divergence opening (23) on the spiral-shaped circumference (28) of the collecting space in the higher-pressure pump space region.

Aspect 42. The pump-motor unit according to any one of the immediately preceding four aspects, wherein the impeller (1) is shaped and/or the return opening (26) is arranged such that the fluid which is channelled back through the return opening (26) exerts a force, having an at least predominant radial component, on the impeller (1).

Aspect 43. The pump-motor unit according to any one of the immediately preceding five aspects, wherein the impeller (1) is shaped and/or the return opening (26) is arranged such that the fluid which is channelled back through the return opening (26) exerts a force, having an at least predominant axial component, on the impeller (1).

Aspect 44. The pump-motor unit according to any one of Aspects 38 to 43 in combination with any one of Aspects 1 to 37.

Aspect 45. The pump-motor unit according to any one of Aspects 38 to 44, wherein the covering structure (3) comprises a circumferential wall (4) which extends axially with respect to the rotational axis (R) of the pump and/or a front-facing wall (5) which extends radially and in the circumferential direction.

Aspect 46. The pump-motor unit according to the preceding aspect, wherein the widening (27), if provided, and/or the return opening (26) face radially opposite the circumferential wall (4) of the covering structure (3) and/or axially opposite the front-facing wall (5) of the covering structure (3) in the clearance.

Aspect 47. The pump-motor unit according to any one of Aspects 38 to 46, wherein the housing comprises a circumferential wall (11), which extends around a longitudinal axis (R) of the housing and surrounds the drive motor (7, 8), and a cooling structure (30) between the motor space and the electronics space which is joined to the circumferential wall of the housing in order to form the cooling channel (33; 37; 38; 19), wherein the cooling channel (33; 37; 38; 19) preferably extends in a joining gap (A; B; C) which the circumferential wall (11) of the housing and the cooling structure (30) form together.

Aspect 48. The pump-motor unit according to the preceding aspect or according to any one of Aspects 1 to 37, wherein the circumferential wall (11) of the housing according to Aspect 1 comprises a motor space opening (13) on the front-facing side, and the cooling structure (30) forms a motor space cover (30) which closes off the motor space opening (13) and separates the electronics space from the motor space, wherein the circumferential wall (11) of the housing preferably terminates axially short of the electronics space.

Aspect 49. The pump-motor unit according to the preceding aspect, wherein the housing comprises an electronics space portion (40) which delimits the electronics space and which is joined directly to the cooling structure (30) only or to the circumferential wall (11) of the housing via the cooling structure (30).

Aspect 50. The pump-motor unit according to Aspect 47 or any one of Aspects 1 to 37, wherein the circumferential wall (11) of the housing surrounds the motor space and the cooling structure (30) and protrudes beyond the cooling structure (30) in both axial directions, and wherein an inner circumference of the circumferential wall (11) of the housing and an outer circumference of the cooling structure (30) lie opposite each other, forming a radial joining gap (C) in which the cooling channel (38) is formed.

Aspect 51. The pump-motor unit according to the preceding aspect, wherein the circumferential wall (11) of the housing also surrounds the electronics space, preferably over its entire length.

Aspect 52. The pump-motor unit according to any one of Aspects 1 to 37 and 47 to 51, wherein the circumferential wall (11) of the housing exhibits a free inner cross-section up to an opening (13) on the front-facing side, wherein said cross-section is large enough that the stator (4) and the rotor (5) can be axially inserted into the motor space up to and into an assembly position or removed from the motor space through the opening (13) on the front-facing side.

Aspect 53. The pump-motor unit according to any one of the preceding aspects, wherein the cooling structure (30) separates the electronics space from the motor space in a dust-proof and/or liquid-proof seal.

Aspect 54. The pump-motor unit according to any one of the preceding aspects, wherein the housing comprises a pump space portion (20) which surrounds the impeller (1).

Aspect 55. The pump-motor unit according to the preceding aspect, wherein the pump space portion (20) forms a collecting space having a circumference (28) which extends in a spiral shape around the impeller (1), starting from a tongue tip of a spiral tongue (29).

Aspect 56. The pump-motor unit according to any one of the immediately preceding two aspects, wherein the pump space portion (20) is formed separately from the circumferential wall (11) of the housing and joined to the circumferential wall (11) of the housing.

Aspect 57. The pump-motor unit according to any one of the preceding aspects in combination with any one of Aspects 26 and 38, wherein the return channel (15, 25) comprises a downstream channel portion (25) which overlaps the impeller (1) in order to channel the fluid which flows back from the cooling channel (33; 37; 38; 19) into the clearance on the suction side of the impeller (1).

Aspect 58. The pump-motor unit according to a combination of the immediately preceding two aspects, wherein the return channel (15, 25) comprises an upstream channel portion (15) which extends in the circumferential wall (11) of the housing, and the overlapping channel portion (25) is formed in the pump space portion (20), such that the overlapping channel portion (25) is connected directly to the upstream channel portion (15) of the circumferential wall (11) of the housing by joining the pump space portion (20) and the circumferential wall (11) of the housing.

Aspect 59. The pump-motor unit according to any one of the preceding aspects, wherein the impeller (1) and the drive motor (7, 8) are arranged such that they can be rotated about the same rotational axis (R).

Aspect 60. The pump-motor unit according to any one of the preceding aspects, comprising a drive shaft (6) which is non-rotationally connected to the impeller (1) and to the rotor (8) of the drive motor (7, 8).

Aspect 61. The pump-motor unit according to any one of the preceding aspects, wherein the longitudinal axis (R) according to any one of Aspects 1 to 37 also forms the rotational axis of the pump and/or the rotational axis of the motor.

Aspect 62. The pump-motor unit according to any one of the preceding aspects, wherein the pump-motor unit is a coolant pump for delivering a cooling fluid, preferably a water-based cooling liquid, in a motor vehicle.

### BRIEF DESCRIPTION OF THE DRAWINGS

Example embodiments of the invention are described below on the basis of figures. Features disclosed by the example embodiments, each individually and in any combination of features, advantageously develop the subject matter of the claims and the above aspects as well as the other embodiments described above. There is shown:

FIG. 1 a first example embodiment of a pump-motor unit in accordance with the invention in an isometric view onto a housing of the unit;

FIG. 2 the pump-motor unit in an axial view onto a fluid inlet;

FIG. 3 the longitudinal section A-A in FIG. 2;

FIG. 4 the longitudinal section B-B in FIG. 2;

FIG. 5 a motor space portion of the housing of the first example embodiment in an isometric view onto an opening on the front-facing side;

FIG. 6 a cooling structure of the first example embodiment in an isometric view;

FIG. 7 the cooling structure of the first example embodiment in a longitudinal section;

FIG. 8 the pump-motor unit of the first example embodiment in a side view;

FIG. 9 the cross-section C-C in FIG. 8;

FIG. 10 a pump-motor unit of a second example embodiment in a side view;

FIG. 11 the cross-section D-D in FIG. 10;

FIG. 12 a pump-motor unit of a third example embodiment in a longitudinal section;

FIG. 13 a cooling structure of the third example embodiment in an isometric view;

FIG. 14 a cooling structure of a fourth example embodiment in an isometric view;

FIG. 15 the cooling structure of the fourth example embodiment in a longitudinal section;

FIG. 16 a pump-motor unit of a fifth example embodiment in a longitudinal section;

FIG. 17 a cooling structure of the fifth example embodiment in a longitudinal section;

FIG. 18 a pump-motor unit of a sixth example embodiment in an isometric longitudinal section;

FIG. 19 a pump-motor unit of a seventh example embodiment in a longitudinal section;

FIG. 20 a pump space portion of the housing of the seventh example embodiment in an axial view onto an inner side;

FIG. 21 a pump-motor unit of an eighth example embodiment in a cross-section through a pump space;

FIG. 22 the pump-motor unit of the eighth example embodiment in a longitudinal section;

FIG. 23 the pump space portion of the housing of the eighth example embodiment in an isometric view; and

FIG. 24 the pump-motor unit of the eighth example embodiment in another longitudinal section.

### DETAILED DESCRIPTION OF THE INVENTION

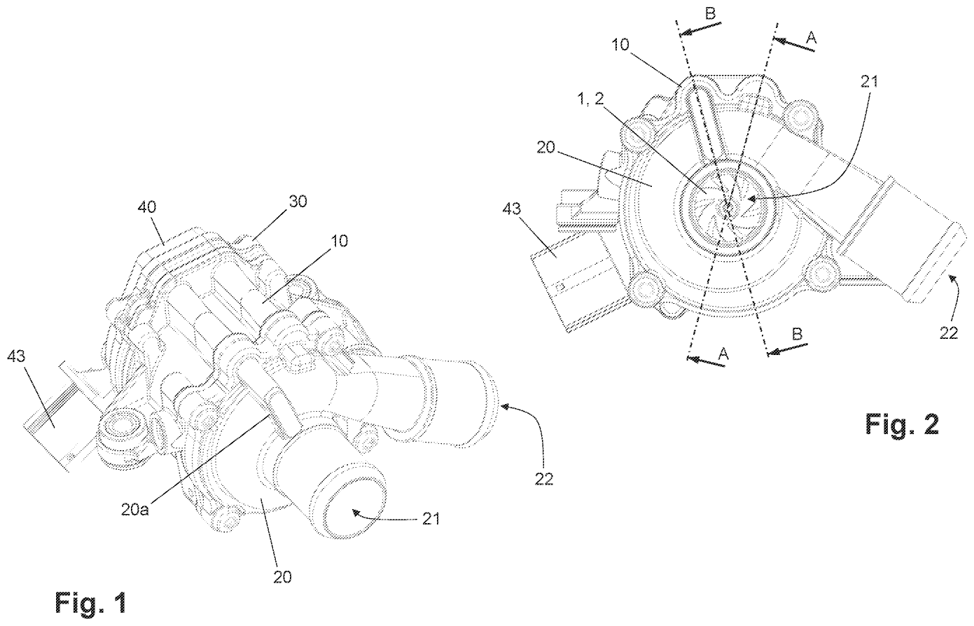

FIGS. 1 to 9 show a pump-motor unit of a first example embodiment. FIG. 1 shows a housing of the pump-motor unit in an isometric view. A pump space through which a fluid flows when the unit is in operation, a motor space and an electronics space are formed in the housing. The housing is accordingly sub-divided into multiple functional housing portions, such as for example a motor space portion 10, a pump space portion 20 and an electronics space portion 40. The pump space portion 20 delimits the pump space. The motor space portion 10 surrounds the motor space, and the electronics space portion 40 delimits the electronics space. The pump space portion 20 comprises a fluid inlet 21 and a fluid outlet 22 for the fluid.

Electronic components of a controller for a drive motor of the unit are accommodated in the electronics space and supplied with electrical energy and/or signals via a port 43.

The pump space, the motor space and the electronics space are arranged sequentially and/or adjacently along a longitudinal axis of the housing, wherein the motor space is situated axially between the pump space and the electronics space. The housing portions 10, 20 and 40 are correspondingly also arranged adjacently along the longitudinal axis of the housing, the pump space portion 20 is arranged on one front-facing side of the motor space portion 10, and the electronics space portion 40 is arranged on the other front-facing side of the motor space portion 10.

In addition to the housing portions 10, 20 and 40, the housing comprises a cooling structure 30 which is arranged axially between the motor space and the electronics space. The cooling structure 30 is used to cool one or more electronics components which is/are accommodated in the electronics space. For the purpose of cooling, a sub-flow of the fluid delivered by the pump-motor unit is diverted in the pump space and guided back into the pump space again in an internal cooling circulation via the cooling structure 30. The internal cooling circulation for cooling the one or more electronics components is generated by a pressure difference in the pump space, by feeding the cooling fluid to the cooling structure 30 from a higher-pressure pump space region and guiding it back from the cooling structure 30 into a relatively lower-pressure pump space region.

In the example embodiment, the housing portions 10, 20 and 40 and the cooling structure 30 are structures which are produced separately from each other and joined together to form the housing, wherein the pump space portion 20 is joined to the motor space portion 10, for example by means of a screw connection, on one front-facing side of the motor space portion 10. The cooling structure 30 and the electronics space portion 40 are joined to the motor space portion 10, for example by means of a screw connection, on the other, opposite front-facing side of the motor space portion 10, wherein the electronics space portion 40 is joined to the motor space portion 10 via the cooling structure 30.

FIG. 2 is an axial view onto the pump space portion 20. An impeller 1 which is rotatably accommodated in the pump space can be seen through the fluid inlet 21. The impeller 1 is radially designed and comprises delivery paddles 2 which can likewise be seen. It is therefore a radial impeller which, when rotationally driven, suctions fluid in the axial direction at the fluid inlet 21, deflects it in the radial and tangential direction using its paddles 2, and discharges it via the at least substantially tangential fluid outlet 22.

Two straight longitudinal sectional lines A-A and B-B which intersect at the longitudinal axis of the housing are indicated in FIG. 2. In the circumferential direction around the longitudinal axis of the housing, fluid is diverted from the higher-pressure pump space region in the circumferential region of the longitudinal section A-A. In the circumferential region of the longitudinal section B-B, the diverted fluid is guided back into the lower-pressure pump space region after it has flowed through the cooling structure 30.

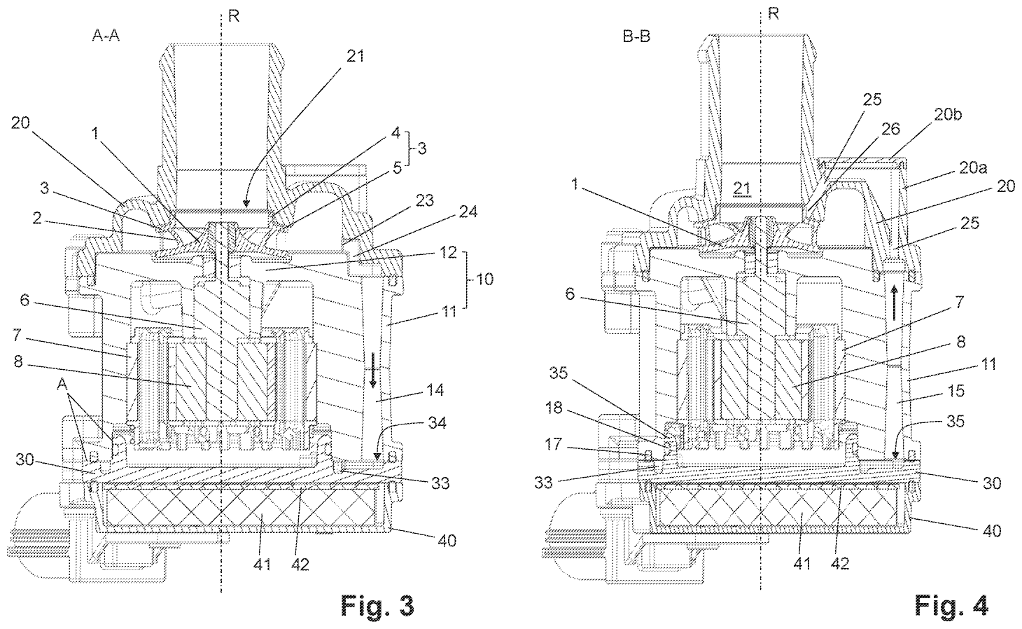

FIGS. 3 and 4 show the longitudinal sections A-A and B-B. A fluid feed line extends from the higher-pressure pump space region to the cooling structure 30 in the longitudinal section A-A of FIG. 3, and a fluid return line extends from the cooling structure 30 into the lower-pressure pump space region in the longitudinal section B-B of FIG. 4.

The impeller 1 is arranged in the pump space such that it can be rotated about a rotational axis R of the pump. The impeller 1 exhibits a suction side, which axially faces the fluid inlet 21, on the front-facing side. The fluid inlet 21 is a flow cross-section, immediately upstream of the impeller 1, which is at least substantially orthogonal with respect to the rotational axis R. On the suction side, the impeller 1 comprises a covering structure 3 at its paddles 2 which extends over 360° around the rotational axis R of the pump and overlaps the paddles 2 in a circumferential strip around the fluid inlet 21. The covering structure 3 and the housing portion 20 together form a clearance which separates the suction side of the impeller 1 from the higher-pressure pump space region. The higher-pressure pump space region comprises in particular a circumferential region of the pump space on the radial periphery of the impeller 1 near the fluid outlet 22 (FIG. 2). The covering structure 3 comprises a circumferential wall 4, which extends axially in relation to the rotational axis R of the pump, and a front-facing wall 5 which extends radially and in the circumferential direction, wherein the circumferential wall 4 and the front-facing wall 5 adjoin each other. The housing portion 20 exhibits a correspondingly shaped inner circumference, such that a narrow clearance is obtained between this inner circumference of the housing portion 20 and the covering structure 3, wherein said clearance comprises an axial clearance portion which follows the outer circumference of the covering structure 3 and a radial clearance portion adjoining it in the direction of the higher-pressure pump space region.

The pump-motor unit comprises an electric drive motor which is arranged in the motor space and comprises a stator 7 and a rotor 8 which is mounted such that it can be rotated about a rotational axis of the motor. The drive motor 7, 8 is arranged coaxially with the impeller 1, such that the rotational axis R of the pump is simultaneously the rotational axis of the motor and is also referred to below merely as the rotational axis R. The rotor 8 is non-rotationally connected to a drive shaft 6, i.e. the motor shaft. The impeller 1 is likewise non-rotationally connected to the drive shaft 6. The drive shaft 6 is mounted in the housing such that it can be rotated about the rotational axis R and is radially and also axially supported by means of the rotational mounting. The rotational axis R is simultaneously the longitudinal axis of the housing mentioned above. It extends centrally through the housing in the longitudinal direction.

The housing portion 10 comprises a circumferential wall 11 of the housing and a front-facing wall 12 of the housing. The circumferential wall 11 of the housing and the front-facing wall 12 of the housing together are cup-shaped, in that the front-facing wall 12 of the housing forms a base of the cup and the circumferential wall 11 of the housing forms a circumferential wall of the cup. The circumferential wall 11 of the housing surrounds the motor space and in particular also the drive motor 7, 8. The drive shaft 6 is mounted, such that it can be rotated about the rotational axis R, in the region of the front-facing wall 12 of the housing. The front-facing wall 12 of the housing can fluidically separate the pump space from the motor space, such that the drive motor 7, 8 can be formed as a dry rotor, as is preferred.

If heat-generating electronics components 41 which require cooling are arranged in the electronics space, these electronics components 41 can be connected in a thermally conductive way to the cooling structure 30. In the example embodiment, the one or more electronics components 41 to be cooled are arranged on the rear side of the cooling structure 30 which faces away from the motor space and are coupled in a thermally conductive way to the cooling structure 30 via a thermally conductive structure 42, for example a thermally conductive pad, and/or a thermally conductive paste. The housing portion 40 surrounds the electronics space and provides a cover for the electronics space on the rear side.

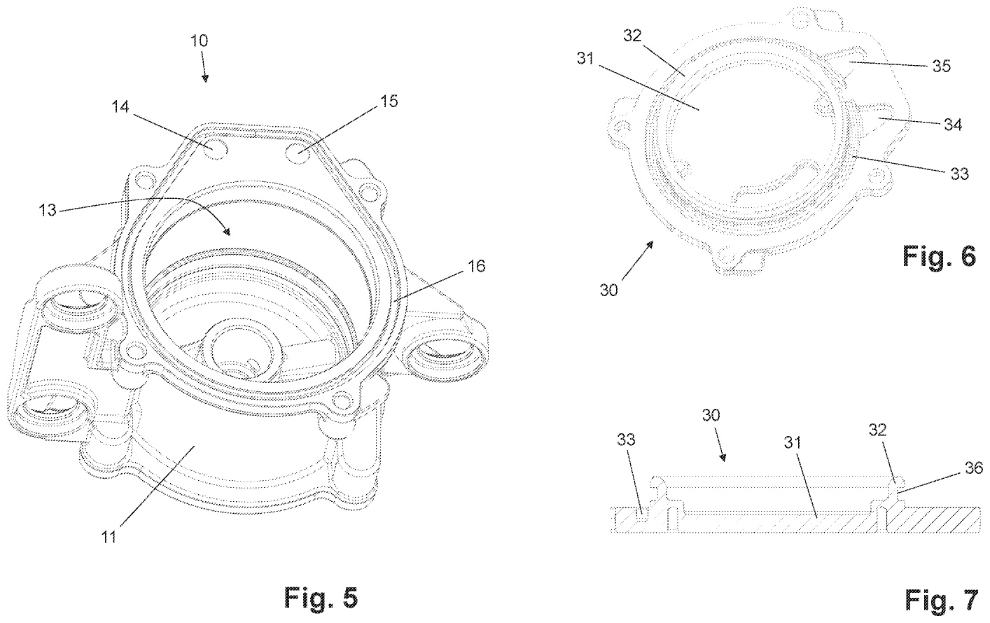

FIGS. 5 and 6 show the housing portion 10 and the cooling structure 30, respectively, separately and before the housing is assembled. The circumferential wall 11 of the housing terminates in an opening on its rear side which faces axially away from the impeller 1, forming a motor space opening 13. The motor space opening 13 and the inner cross-section of the circumferential wall 11 of the housing are large enough that the rotor 8 and the stator 7 can be axially inserted into the motor space up to and into the intended installation position via the motor space opening 13.

The cooling structure 30 comprises a front-facing wall 31 and a circumferential wall 32 which protrudes axially from the front-facing wall 31 of the cooling structure. The front-facing wall 31 of the cooling structure comprises a passage for connecting conduits which connect the drive motor (in the example embodiment, the stator 7 which is provided with electrical coils) to the electronics which are accommodated in the electronics space (preferably an electronic controller for the drive motor). The passage lies within the circumferential wall 32 of the cooling structure, as viewed in an axial top view.

When the joining structures are joined, as shown in FIGS. 3 and 4, the circumferential wall 11 of the housing and the cooling structure 30 form a joining gap A which extends around the longitudinal axis of the housing and/or the rotational axis R and thus “around the corner”. The circumferential wall 32 of the cooling structure 30 protrudes through the motor space opening 13 into the motor space, such that the circumferential wall 11 of the housing and the circumferential wall 32 of the cooling structure axially overlap and form a radial joining gap in their axial overlap. This joining gap is referred to as a radial joining gap or radial joining gap portion because the axially overlapping circumferential walls 11 and 32 lie radially opposite each other across the joining gap. The front-facing wall 31 of the cooling structure protrudes radially outwards beyond the circumferential wall 32 of the cooling structure and, when the joining structures are joined, radially overlaps in the region of the protruding front-facing wall with a front-facing surface of the circumferential wall 11 of the housing. The circumferential wall 11 of the housing and the front-facing wall 31 of the cooling structure form an axial joining gap, which extends around the rotational axis R, in their radial overlap. This joining gap is referred to as an axial joining gap or axial joining gap portion because the front-facing wall 32 of the cooling structure and the front-facing surface of the circumferential wall 11 of the housing which faces it lie axially opposite each other in their radial overlap. In the first example embodiment, the radial joining gap portion and the axial joining gap portion together form the joining gap A which extends “around the corner”.

A cooling channel 33 extends around the rotational axis R in the joining gap A. In the first example embodiment, the cooling channel 33 is formed as a recess which extends around the circumferential wall 32 of the cooling structure (FIG. 6) on the outer side in the front-facing wall 31 of the cooling structure and, when the joining structures are joined, at least substantially in the axial joining gap portion only. The cooling channel 33 is sealed off on the radially outer side in the axial joining gap portion by means of an outer sealing element 17 and sealed off from the motor space on the radially inner side in the radial joining gap portion by means of an inner sealing element 18. The outer sealing element 17 can be a sealing ring which acts as an axial gasket, and the inner sealing element 18 can be a sealing ring which acts as a radial gasket.

FIG. 3 shows the fluid feed line from the higher-pressure pump space region up to the cooling channel 33. The fluid feed line is formed by a feed channel which comprises a downstream feed channel portion 14 and an upstream feed channel portion 24. The downstream feed channel portion 14 emerges into a cooling channel inlet 34 of the cooling channel 33. The upstream feed channel portion 24 extends up to the higher-pressure pump space region and is connected to this pump space region via a divergence opening 23. The channel portion 24 emerges directly into the channel portion 14. The downstream feed channel portion 14 extends peripherally from the drive motor 7, 8 through the circumferential wall 11 of the housing. It can in particular extend in an axial straight line through the circumferential wall 11 of the housing and emerge at two front-facing surfaces of the circumferential wall 11 of the housing which face away from each other.

The upstream feed channel portion 24 is delimited on the radially inner side by the motor space portion 10 and on the radially outer side by the pump space portion 20, i.e. the two housing portions 10 and 20 together define the channel portion 24. The housing can comprise a local, axially protruding dome 20a in the region of the housing portion 20 in order to guide the return channel (in the example embodiment, the return channel portion 25) past the impeller 1 to the clearance. The dome 20a exhibits an opening in order to facilitate producing an end portion of the return channel 15, 25 which extends at an angle to the rotational axis R up to the return opening 26. A cover element 20b closes off this opening. The dome 20a and its position in relation to the pump space can also be seen in FIGS. 1 and 2.

FIG. 4 shows the fluid return line from the cooling channel 33 up to and into the lower-pressure pump space region. The fluid return line is formed by a return channel which comprises an upstream return channel portion 15 and a downstream return channel portion 25 adjoining it. The upstream end of the channel portion 15 adjoins a cooling channel outlet 35 of the cooling channel 33, and the downstream end of the channel portion 15 emerges into the continuative channel portion 25. The upstream channel portion 15 extends peripherally from the drive motor 7, 8 through the circumferential wall 11 of the housing. It can in particular extend in an axial straight line through the circumferential wall 11 of the housing and emerge at two front-facing surfaces of the circumferential wall 11 of the housing which face away from each other.

The downstream return channel portion 25 extends from the upstream return channel portion 15 up to a return opening 26 which is formed in the pump space portion 20 and lies opposite the covering structure 3 of the impeller 1 across the clearance. The return channel 15, 25 overlaps the impeller 1, as viewed from the cooling structure 33, in order to channel the fluid which flows back from the cooling channel 33 on the suction side of the impeller 1 into the clearance between the impeller 1 and the housing and/or pump space portion 20, where the fluid pressure of the fluid which flows back is applied to the covering structure 3. The fluid which flows back exerts an axial force and/or a radial force on the covering structure 3 and thus on the impeller 1. The force exerted by the fluid which flows back is used to compensate for forces which act on the impeller 1 when the pump is in operation due to the fluid being delivered and which have to be absorbed in its rotational mounting, as is described further below.

The cooling channel 33 can extend as an axial extension of the feed channel portion 14, such that the latter emerges directly, with no transition, into the cooling channel 33. The cooling channel inlet would simply be a portion, preferably an end portion, of the cooling channel 33. The feed channel portion 14 can instead also emerge into the cooling channel inlet 34 peripherally with respect to the cooling channel 33, as in the example embodiment. The cooling channel inlet 34 therefore extends radially outwards from the cooling channel 33, as viewed in an axial top view, in order to establish the connection to the feed channel portion 14. The cooling channel inlet 34 is a radial widening of the cooling channel 33, wherein the cooling channel 33 can be offset from the cooling channel inlet 34, for example axially lower than the cooling channel inlet 34.

The cooling channel 33 can extend as an axial extension of the return channel portion 15, such that the latter emerges directly, with no transition, into the cooling channel 33. The cooling channel outlet would simply be a portion, preferably an end portion, of the cooling channel 33. The return channel portion 15 can instead also emerge into the cooling channel outlet 35 peripherally with respect to the cooling channel 33, as in the example embodiment. The cooling channel outlet 35 therefore extends radially outwards from the cooling channel 33, as viewed in an axial top view, in order to establish the connection to the return channel portion 15. The cooling channel outlet 35 is a radial widening of the cooling channel 33, wherein the cooling channel 33 can be offset from the cooling channel outlet 35, for example axially lower than the cooling channel outlet 35.

When the pump-motor unit is in operation, the fluid is suctioned by the rotating impeller 1 at the fluid inlet 21, deflected radially outwards and tangentially by means of the paddles 2 such that a rotational flow around the rotational axis R is created, and discharged at least substantially tangentially via the fluid outlet 22. In order to cool the one or more electronics components 41, a sub-flow is diverted from this main flow via the divergence opening 23 in the higher-pressure pump space region. The diverted sub-flow flows through the feed channel portions 24 and 14, sequentially in the inflow direction, and flows via the cooling channel inlet 34 into the cooling channel 33 which extends annularly around the rotational axis R in the joining gap A. In the cooling channel 33, the fluid flows around the rotational axis R towards the cooling channel outlet 35, whence it flows into the return channel portion 15, flows through the return channel portion 15 and the return channel portion 25 adjoining it in the return flow direction, and flows through the return opening 26 into the clearance between the housing and the impeller 1. The inflow direction and the return flow direction are each indicated by a flow arrow in FIGS. 3 and 4.

With respect to sealing off the joining gap A, it should also be added that the outer sealing element 17 extends around the rotational axis R and the motor space opening 13 in the axial joining gap portion, including the cooling channel inlet 34 and the cooling channel outlet 35. The sealing element 17 can be accommodated in a correspondingly extending receptacle of the cooling structure 30 or, as in the example embodiment, in a receptacle 16 of the circumferential wall 11 of the housing which can be seen on the front-facing side in FIG. 5. The receptacle 16 encircles the rotational axis R and the motor space opening 13 on the front-facing surface of the circumferential wall 11 of the housing, with which the circumferential wall 11 of the housing axially delimits the joining gap A, including where the channel portions 14 and 15 emerge and, when the joining structures are joined, the cooling channel inlet 34 and the cooling channel outlet 35. The inner sealing element 18 extends around the rotational axis R in the radial joining gap portion. The sealing element 18 can be accommodated in a correspondingly extending receptacle of the circumferential wall 11 of the housing or, as in the example embodiment, in a receptacle of the cooling structure 30. FIG. 7 shows the cooling structure 30 in a longitudinal section in which the cooling channel 33 and said receptacle 36 for the inner sealing element 18 can be seen. The receptacle 36 extends on the outer circumference of the circumferential wall 32 of the cooling structure, with which the cooling structure 30 delimits the joining gap A on the radially inner side when the joining structures are joined.

As already mentioned, the cooling channel 33 extends annularly around the rotational axis R. The cooling channel 33 can in principle be a self-contained cooling channel ring, i.e. it can encircle the rotational axis R over an arc angle of 360° and meet itself. In such embodiments, the inflowing fluid would be bifurcated at the cooling channel inlet 34 and flow in both circumferential directions around the rotational axis R towards the cooling channel outlet 35, wherein the relative mass flows would depend on the flow resistances of the two legs. It is more advantageous for the cooling channel 33 to extend around the rotational axis R from the cooling channel inlet 34 up to the cooling channel outlet 35 in one circumferential direction only, as in the example embodiments. It is advantageous for the cooling channel 33 to extend around the rotational axis R from the cooling channel inlet 34 up to the cooling channel outlet 35 over an arc angle of at least 270° or at least 300°. It is also advantageous for the cooling channel inlet 34 to have an angular distance of at most 90° or at most 60° from the cooling channel outlet 35 in the circumferential direction around the rotational axis R, wherein the angular distance between the points closest to each other are measured at the rim of the cooling channel inlet 34 and cooling channel outlet 35.

The cooling channel inlet 34 and the cooling channel outlet 35 can lie adjacently at a certain distance, as can be seen by way of example in FIG. 6. In order to fluidically separate them, a sealing element can be arranged between the cooling channel inlet 34 and the cooling channel outlet 35, for example a sealing ring which surrounds one of the cooling channel inlet 34 and the cooling channel outlet 35 and thus separates it from the other. It is more advantageous for the joining gap A between the cooling channel inlet 34 and the cooling channel outlet 35 to be embodied such that a fluidic separation is ensured solely by a sealing contact between the joining partners 11 and 30. A sealing section of at least 3 mm or at least 5 mm in the circumferential direction should be provided. A sealing surface and/or sealing section which can then remain between the ends of the cooling channel 33 and in particular between the cooling channel inlet 34 and the cooling channel outlet 35 in the circumferential direction around the rotational axis R is sufficient to fluidically separate the ends of the cooling channel 33 from each other and to fluidically separate the cooling channel inlet 34 from the cooling channel outlet 35 by way of the contact between the joining partners 11 and 30. In order to provide a sufficient sealing section, the cooling channel inlet 34 can exhibit an angular distance of at least 10° or at least 20° or at least 30° from the cooling channel outlet 35 in the circumferential direction about the rotational axis R.

The feed channel portion 14 and the return channel portion 15 extend adjacently through the circumferential wall 11 of the housing at an angular distance, measured in the circumferential direction, corresponding to the cooling channel inlet 34 and cooling channel outlet 35. The angular distance between the two channel portions 14, 15 is measured between the points on the rim of the channel portions 14, 15 closest to each other and is preferably at most 90° or at most 60°, but can conversely be at least 10° or at least 20° or at least 30°.

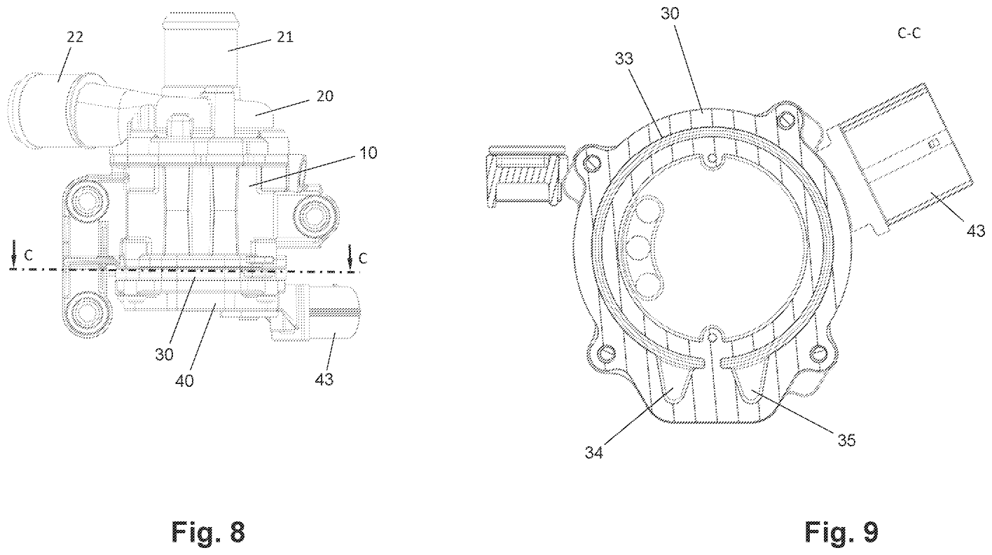

In the side view of FIG. 8, the sectional line is indicated for the cross-section C-C which is shown in FIG. 9. The cross-section C-C extends orthogonally with respect to the rotational axis R through the cooling channel 33, the cooling channel inlet 34 and the cooling channel outlet 35, i.e. the cross-section C-C extends immediately below the front-facing surface of the cooling structure 30 which delimits the axial gap portion of the joining gap A when the joining structures are joined. As can be seen in particular in FIG. 9, an advantageous embodiment of the cooling channel 33 can extend around the rotational axis R from the cooling channel inlet 34 up to the cooling channel outlet 35 over an arc angle of more than 320°. A sufficiently large sealing section for fluidically separating the cooling channel inlet 34 and the cooling channel outlet 35 nonetheless remains in the joining gap A immediately between the joining partners 11 and 30.

Where the feed channel 14, 24 and the return channel 15, 25 extend through the circumferential wall 11 of the housing, they extend peripherally from the drive motor 7, 8, such that they can for example be provided as simple axial transit bores in the circumferential wall 11 of the housing. It is also advantageous for the cooling channel inlet 34 and the cooling channel outlet 35 to be located radially outside a virtual minimum enclosing circular cylinder which envelops the drive motor 7, 8 over its outer circumference. The cooling channel 33 can advantageously extend radially outside the imaginary enclosing circular cylinder over its entire profile, not least in order to bring the largest possible surface of the cooling structure 30 into heat-exchanging contact with the fluid used for cooling, despite the cooling channel 33 being provided in a simple design.

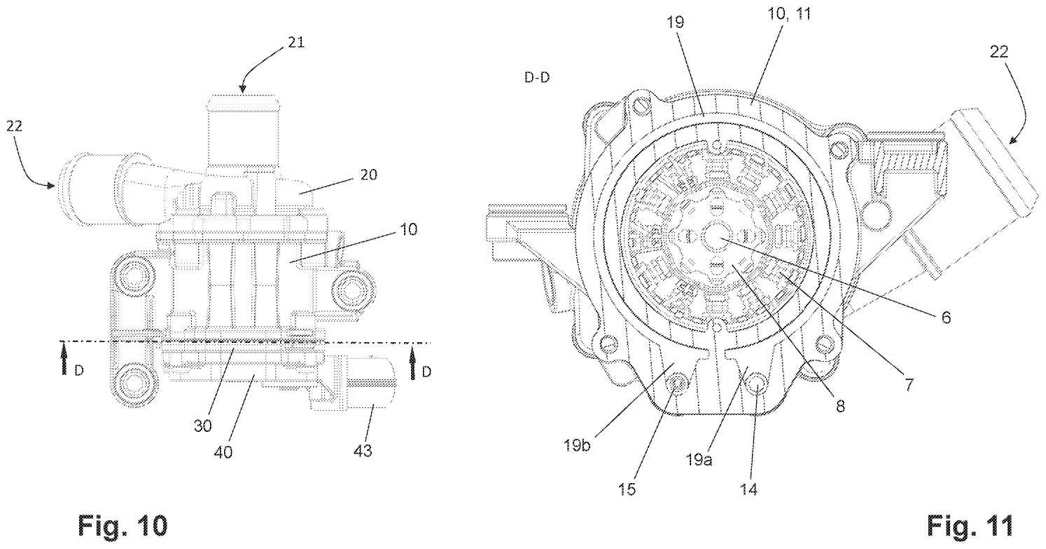

FIG. 10 shows a pump-motor unit of a second example embodiment in a side view onto the housing of the unit. The sectional line of a cross-section D-D of the pump-motor unit is indicated.

FIG. 11 shows the cross-section D-D which extends orthogonally with respect to the rotational axis R through the circumferential wall 11 of the housing in the immediate vicinity of the axial joining gap portion of the circumferential wall 11 of the housing and the cooling structure 30. In the second example embodiment, the cooling channel is not formed as a recess in the front-facing wall of the cooling structure 30 but rather on the front-facing surface of the circumferential wall 11 of the housing and is referred to as the cooling channel 19 to distinguish it from the first example embodiment. The cooling channel 19 is shaped as a mirror image of the cooling channel 33 of the first example embodiment and extends from the cooling channel inlet 19a up to the cooling channel outlet 19b over an arc angle of more than 270° or more than 300°. The cooling channel inlet 19a and the cooling channel outlet 19b are expediently likewise formed in the front-facing surface of the circumferential wall 11 of the housing. The cooling structure 30 can therefore comprise a simply planar front-facing wall which axially delimits the cooling channel 19, the cooling channel inlet 19a and the cooling channel outlet 19b. Aside from the differences described, the pump-motor unit of the second example embodiment corresponds to the unit of the first example embodiment, such that reference is made to the statements made above.

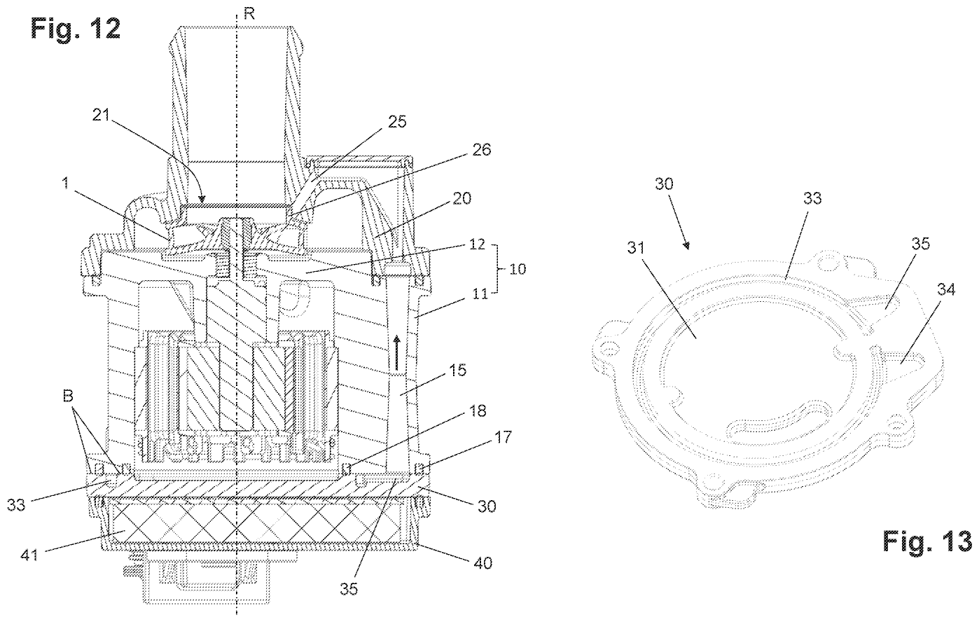

FIGS. 12 and 13 show a pump-motor unit of a third example embodiment in a longitudinal section and the cooling structure 30 of the third example embodiment in an isometric view. Unlike the first and second example embodiments, the circumferential wall 11 of the housing and the cooling structure 30 form a purely axial joining gap B in which the circumferential wall 11 of the housing and the cooling structure 30 only overlap radially. The cooling channel 33, the cooling channel inlet 34 and the cooling channel outlet 35 are formed in the axial joining gap, as in the first and second example embodiments, and are each formed as an axial recess on the front-facing wall 31 of the cooling structure, as in the first example embodiment. In one modification in accordance with the second example embodiment, each of the cooling channel 33, the cooling channel inlet 34 and the cooling channel outlet 35 can instead be formed as an axial recess on the front-facing side of the circumferential wall 11 of the housing.

The cooling channel 33 is sealed off on the radially outer side by means of an outer sealing element 17 and sealed off from the motor space on the radially inner side by means of an inner sealing element 18 in the joining gap B. The two sealing elements 17 and 18 can be sealing rings which act as axial gaskets. Aside from the differences described, the pump-motor unit of the third example embodiment corresponds to the units of the first and second example embodiments, such that reference is made to the statements made above.

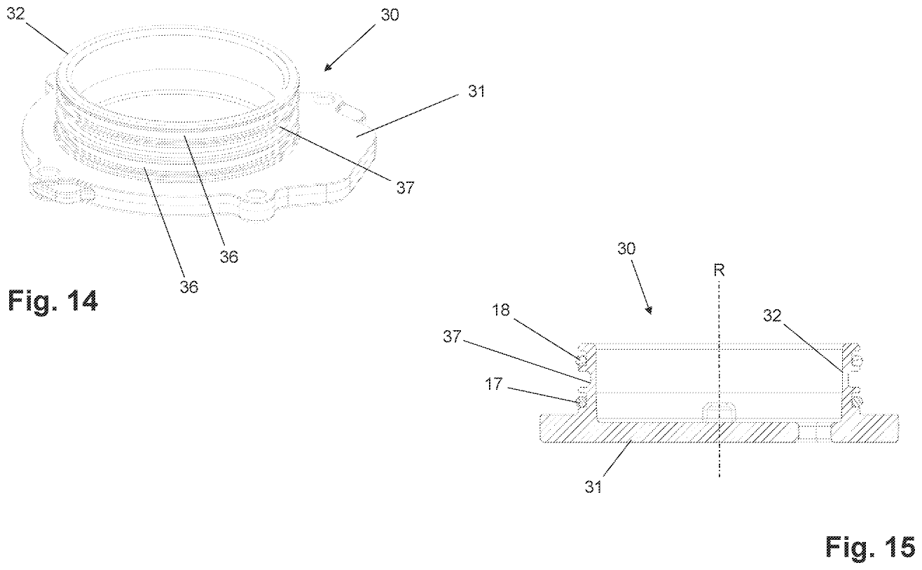

FIGS. 14 and 15 show a cooling structure 30 for a pump-motor unit of a fourth example embodiment. In the fourth example embodiment, a cooling channel 37 extends in the radial joining gap portion of the joining gap A which, as in the first and second example embodiments, extends “around the corner” and therefore largely corresponds to the joining gap of the first example embodiment. The cooling channel 37 is again not fully circumferential, i.e. does not form a self-contained cooling channel ring, but rather extends around the rotational axis R of the pump-motor unit from the cooling channel inlet (not shown) up to the cooling channel outlet (likewise not shown) over an arc angle of less than 360º only, but at least 270° or at least 300°. The ports to the feed channel which extends through the circumferential wall of the housing and to the return channel which likewise extends through the circumferential wall of the housing, i.e. the cooling channel inlet and the cooling channel outlet, are advantageously formed in the region of the circumferential wall of the housing.

As shown in the longitudinal section of FIG. 15, the cooling channel 37 is sealed off on both sides of the channel by means of an outer sealing element 17 and an inner sealing element 18. The sealing elements 17 and 18 can in particular each be a sealing ring which acts as a radial gasket and are each accommodated in a receptacle 36 of the cooling structure 30, wherein the receptacles 36 and correspondingly the sealing elements 17 and 18 are formed and/or arranged on the outer circumference of the circumferential wall 32 of the cooling structure. Aside from the differences described, which are apparent from FIGS. 14 and 15, the pump-motor unit of the fourth example embodiment corresponds to the pump-motor units shown and described above, such that reference is otherwise made to the statements made above.

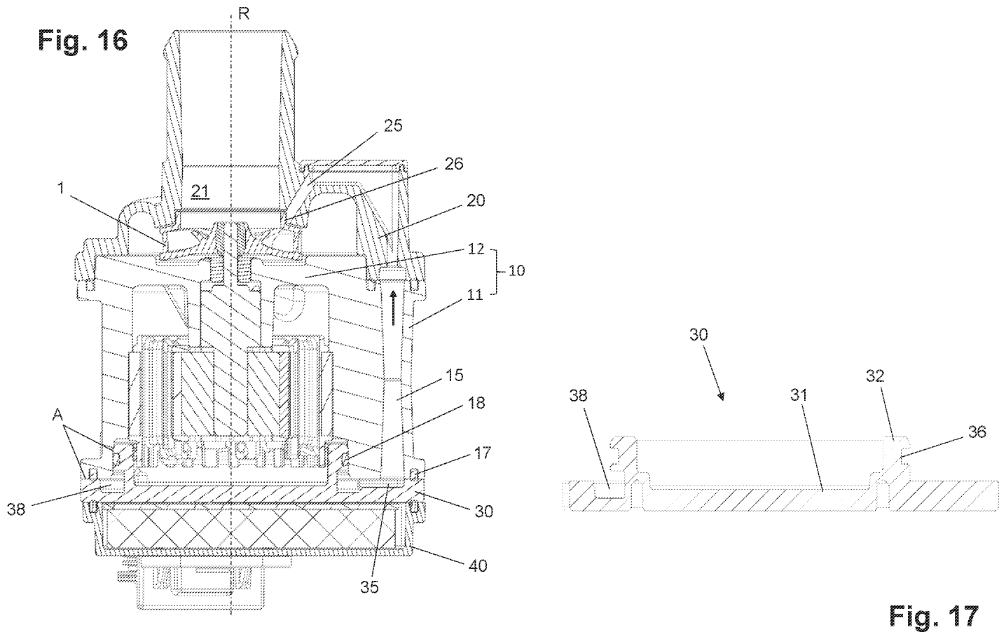

FIG. 16 shows a pump-motor unit of a fifth example embodiment in a longitudinal section, and FIG. 17 shows the cooling structure of the fifth example embodiment, likewise in a longitudinal section.

The pump-motor unit of the fifth example embodiment differs from the unit of the first example embodiment only in that a cooling channel 38 is formed in the joining gap A which extends around the corner, wherein the cooling channel 38 likewise extends around the corner and the circumferential wall 11 of the housing also corresponds to the circumferential wall 11 of the first example embodiment in the region of the joining gap A. The cooling structure 30, by contrast, is modified. The cooling channel 38, which extends annularly around the circumferential wall 32 of the cooling structure, is composed of an axial recess on the front-facing surface of the front-facing wall 31 of the cooling structure, which axially delimits the joining gap A, and an adjoining radial recess on the outer circumference of the circumferential wall 32 of the cooling structure. The cooling channel 38 therefore extends into both the axial joining gap portion and the radial joining gap portion of the joining gap A. The circumferential wall 32 of the cooling structure is axially extended as compared to the first example embodiment by the extent to which the cooling channel 38 extends into the radial joining gap portion. The cooling structure 30 and also the pump-motor unit of the fifth example embodiment otherwise correspond to the first example embodiment.

In the first to sixth example embodiments, the circumferential wall 11 of the housing surrounds the motor space and terminates axially short of the electronics space at the motor space opening 13 (FIG. 5). In these example embodiments, the cooling structure 30 forms a motor space cover, and the electronics space portion 40 is provided and joined as a separately produced housing portion, such that it not only delimits the electronics space on the rearward front-facing side but also surrounds it over the circumference.

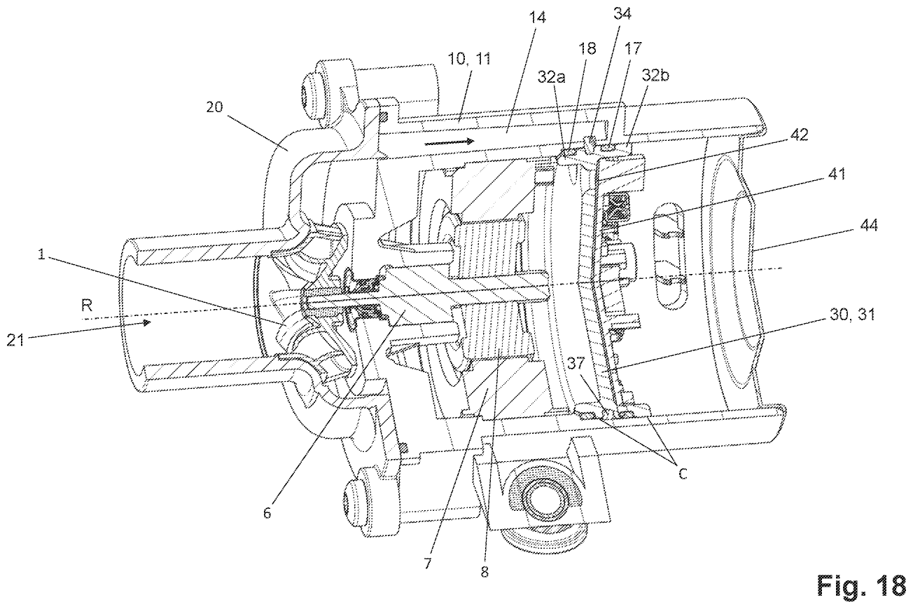

FIG. 18 shows a pump-motor unit of a sixth example embodiment in an isometric longitudinal section. The circumferential wall 11 of the housing of the sixth example embodiment is axially extended as compared to the other example embodiments. It surrounds not only the motor space but also the electronics space. Accordingly, the cooling structure 30 does not form a motor space cover, but is rather axially inserted into the extended circumferential wall 11 of the housing up to and into the joining position assumed in FIG. 18. However, it also separates the electronics space from the motor space in the sixth example embodiment by preventing dirt particles and/or moisture from being able to penetrate from the motor space into the electronics space.

The cooling structure 30 comprises a front-facing wall 31, a circumferential wall 32a which protrudes axially into the motor space from the front-facing wall 31 of the cooling structure, and another circumferential wall 32b which protrudes axially in the other direction into the electronics space from the front-facing wall 31 of the cooling structure. The two circumferential walls 32a and 32b of the cooling structure extend annularly around the front-facing wall 31 of the cooling structure. When the joining structures are joined, as shown in FIG. 18, the circumferential walls 32a and 32b of the cooling structure each overlap in the axial direction with the circumferential wall 11 of the housing and therefore each form a radial joining gap portion of a joining gap C, which is a radial joining gap overall, with the circumferential wall 11 of the housing. The circumferential wall 11 of the housing exhibits a smooth inner circumference over the axial length of the joining gap C.

The cooling structure 30 comprises a radial recess on its outer circumference which extends annularly around the rotational axis R from the cooling channel inlet 34 (which can be seen in FIG. 18) up to the cooling channel outlet (which is not included in the section) and forms the cooling channel 37. With respect to how the cooling channel 37 extends, the statements already made with respect to the other example embodiments apply. The cooling channel 37 can then for example extend from the cooling channel inlet up to the cooling channel outlet over an arc angle of at least 270° or at least 300° and less than 360º in one circumferential direction only. With regard to how it adjoins the cooling channel inlet and the cooling channel outlet, reference is made to the statements made with respect to the fourth example embodiment (FIGS. 14 and 15).

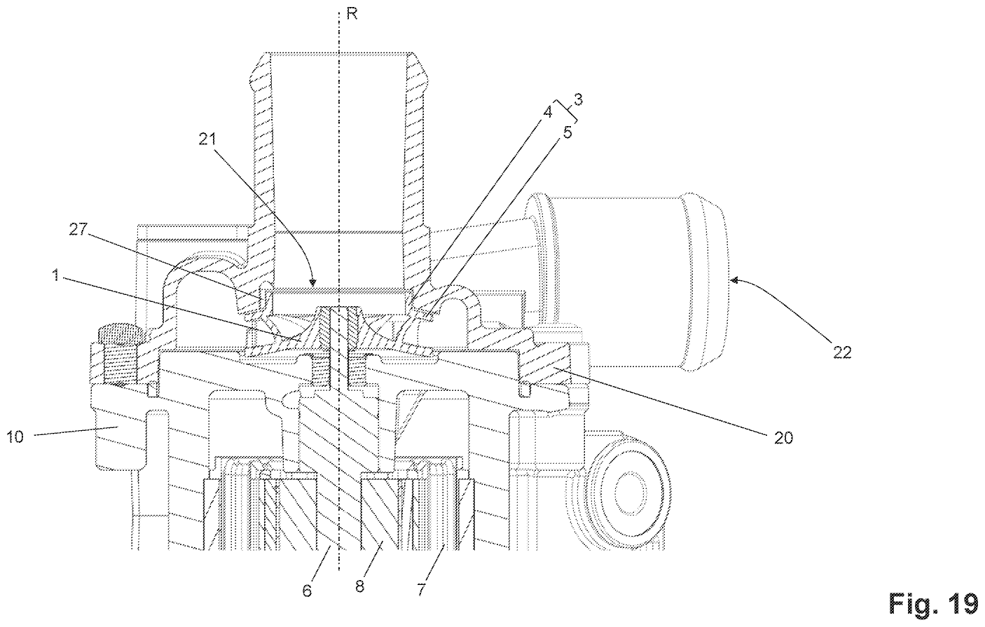

FIG. 19 shows a pump-motor unit of a seventh example embodiment in a longitudinal section. Only the front region comprising the pump space is shown. In the rear region, in particular the joining region between the circumferential wall 11 of the housing and the cooling structure 30, and in the implementation of the cooling channel, the pump-motor unit can selectively correspond to any one of the other example embodiments described above. The only difference with respect to the example embodiments hitherto described is in the fluid return line, specifically the region of the clearance between the impeller 1 and the housing portion 20, which comprises a local widening 27 opposite the covering structure 3. The widening 27 radially widens the clearance, but not over its full circumference. It extends around the rotational axis only over a certain arc angle. It can form a ring sector which lies radially opposite the circumferential portion 4 of the covering structure 3. The widening 27 can extend axially up to the clearance, as in the example embodiment, such that it lies axially opposite the front-facing wall 5 of the covering structure 3 and therefore also axially widens the clearance over its angular extent.

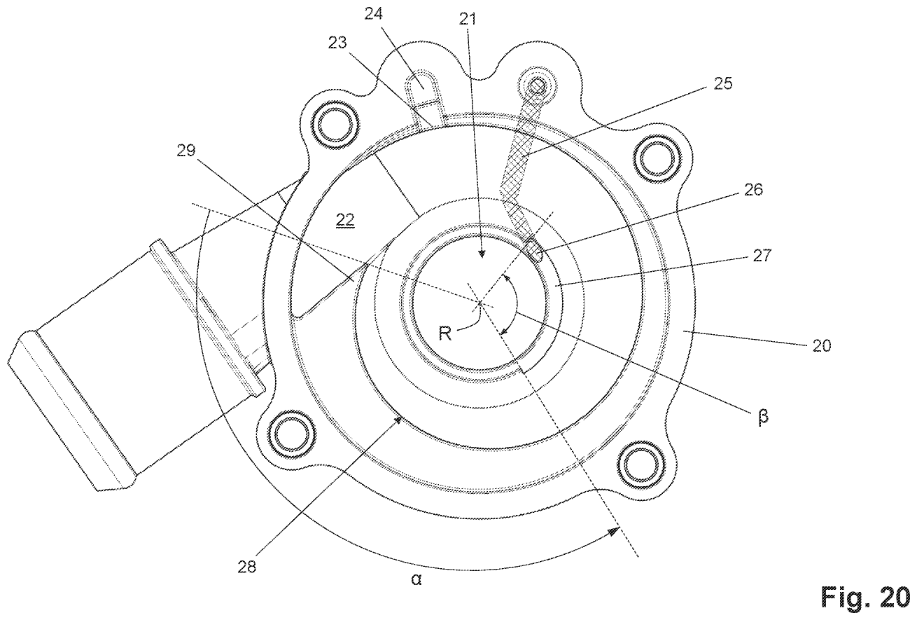

FIG. 20 is an axial view onto the inner side of the housing portion 20. The housing portion 20 surrounds the pump space and the impeller 1 arranged in it over the circumference and also delimits the pump space on its front-facing side which faces axially away from the motor space. The housing portion 20 comprises the fluid inlet 21 and the fluid outlet 22. The housing portion 20 delimits a collecting space axially and around the rotational axis R, wherein the collecting space extends around the impeller 1 and is delimited on the radially outer side by a circumference 28 of the pump space portion 20. The circumference 28 extends in a spiral shape around the rotational axis R, wherein the radius of the circumferential wall 28 as measured onto the rotational axis R increases continuously in the rotational direction of the impeller 1 from the tip of a spiral tongue 29 up to the fluid outlet 22. The fluid outlet 22 is understood to be a flow cross-section of the collecting space which extends radially outwards from the tip of the spiral tongue 29 up to the spiral-shaped circumference 28. The fluid flows out of the collecting space at the fluid outlet 22 in an at least substantially tangential direction. The fluid outlet 22 is adjoined by an outlet fitting which extends at least substantially tangentially with respect to the collecting space, such that the outflowing fluid continues to flow in a tangentially straight direction.

The divergence opening 23 and the channel portion 24 of the feed channel which adjoins it in the flow direction of the diverted fluid can be seen in FIG. 20. The divergence opening 23 is situated near the fluid outlet 22, slightly short of the fluid outlet 22 in the rotational direction of the impeller 1, in the radially outer region of the collecting space and therefore in the higher-pressure pump space region. The divergence opening 23 exhibits an angular distance of less than 90° from the tongue tip of the spiral tongue 29 counter to the rotational direction. In the example embodiment, the divergence opening 23 is formed on the inner circumference of the housing portion 20, such that the fluid for the integrated cooling system is diverted at the periphery of the rotational flow which is established when the pump is in operation.

The return opening 26 is situated radially further inwards than the divergence opening 23 and upstream of the divergence opening 23 in relation to the rotational flow which is established. The channel portion 25 of the return channel which emerges into the pump space via the return opening 26 is indicated in FIG. 19, although it does not extend in the pump space but rather only outside the pump space, overlapping the impeller 1.

The return opening 26 is arranged such that the fluid which flows into the clearance between the impeller 1 and the housing at the return opening 26 exerts a radial compensating force on the impeller 1, i.e. on its covering structure 3, which counteracts and at least partially compensates for a radial force which acts on the impeller 1 due to the fluid being delivered. If the pump space is notionally sub-divided at the rotational axis R, as viewed in an axial top view, into a first hemisphere which includes the fluid outlet 22 and a second hemisphere in which the return opening 26 is situated, then the radial compensating force is directed towards the first hemisphere.

In relation to the circumferential direction around the rotational axis R, the return opening 26 exhibits an angular distance of at least 90° or at least 120° from the tongue tip of the spiral tongue 29 in the rotational direction. Counter to the rotational direction, the angular distance can be more than 60° or at least 90°. It is advantageous for the angular distance in the rotational direction to be greater than the angular distance counter to the rotational direction, wherein this is also related to the arrangement of the divergence opening 23 and the fluid feed line and fluid return line of the integrated cooling system.

In order to better compensate for the radial forces, the housing portion 20 comprises the widening 27 in the region of the clearance, wherein the widening 27 radially and also axially widens the clearance in a circumferential region which lies opposite the tongue tip of the spiral tongue 29 as viewed across the rotational axis R. In the top view, the widening exhibits the shape of a ring sector. The channel portion 25 of the return channel emerges at the return opening 26 in the region of the widening 27. In the example embodiment, it emerges at a circumferential end of the widening 27 which is a downstream end in the flow direction of the rotational flow. The widening 27 extends counter to the rotational direction of the impeller 1 from the downstream circumferential end up to an upstream circumferential end over an arc angle β. The upstream circumferential end exhibits an angular distance a from the tongue tip of the spiral tongue 29, wherein the arc angle α is measured in the rotational direction of the impeller 1 from the tongue tip up to the upstream circumferential end of the widening 27. In advantageous embodiments, it also holds that the widening 27 exhibits an angular distance a of at least 90° from the tongue tip of the spiral tongue 29 both in and counter to the rotational direction of the impeller 1. In the example embodiment, the angular distance a is between 90° and 180º. The circumferential extent of the widening 27, measured as the arc angle β, can be more than 40° or more than 60º. Conversely, its circumferential extent should be at most 180º or at most 150°.

The example embodiments described above can be formed as in the seventh example embodiment with regard to the pump space and in particular the divergence opening 23 and/or the return opening 26 and with regard to the housing portion 20. In order to influence the radial and/or axial compensating force, they can also comprise the widening 27. If they do not comprise the widening 27, the return opening 26 can be arranged offset by a certain arc angle counter to the rotational direction of the impeller 1, wherein the angular offset should be at most as large as the angular extent B of the widening 27. The offset return opening 26 would be situated in the circumferential region between the circumferential ends of the widening 27 of the seventh example embodiment.

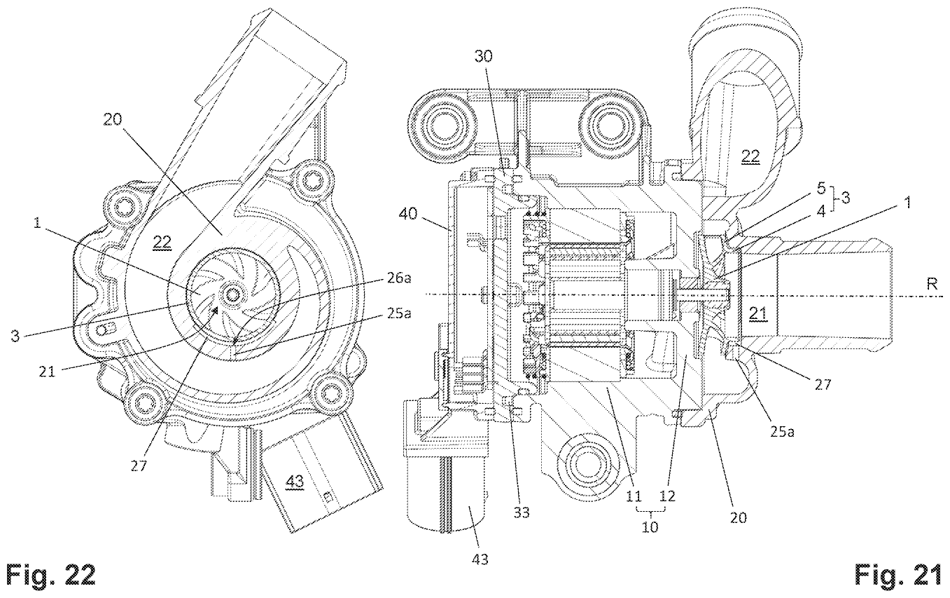

FIGS. 21 to 24 show a pump-motor unit of an eighth example embodiment in which a compensating force for relieving the rotational mounting of the impeller 1 is not generated by the fluid of the integrated cooling system which flows back but rather by means of fluid which is diverted directly from the higher-pressure pump space region.

FIG. 21 shows the pump-motor unit of the eighth example embodiment in a longitudinal section. In the longitudinal section, a connecting channel 25a can be seen which extends from the higher-pressure pump space region up to and into the clearance between the impeller 1 and the housing portion 20 over a short distance through the housing portion 20. The clearance comprises the widening 27 which has been described with respect to the seventh example embodiment. The connecting channel 25a emerges into the widening 27 and exerts a radial and/or axial compensating force on the covering structure 3 and therefore on the impeller 1 in the clearance, as already described above.

FIG. 22 shows the pump-motor unit in a cross-section which extends orthogonally with respect to the rotational axis R near the suction-side front-facing end of the covering structure 3, axially level with the connecting channel 25a, through the circumferential portion 4 of the covering structure 3. The covering structure 3 can therefore be seen as a ring. The widening 27, the short straight connecting channel 25a and the channel opening 26a, at which the connecting channel 25a emerges into the clearance in the circumferential region of the widening 27, can also be seen. The channel opening 26a is located in a middle region of the widening 27 in the circumferential direction, such that higher-pressure fluid which is channelled into the clearance via the connecting channel 25a is distributed in the widening 27 to the left and right around the covering structure 3 in order to exert the radial compensating force and preferably also a certain axial compensating force on the covering structure 3.

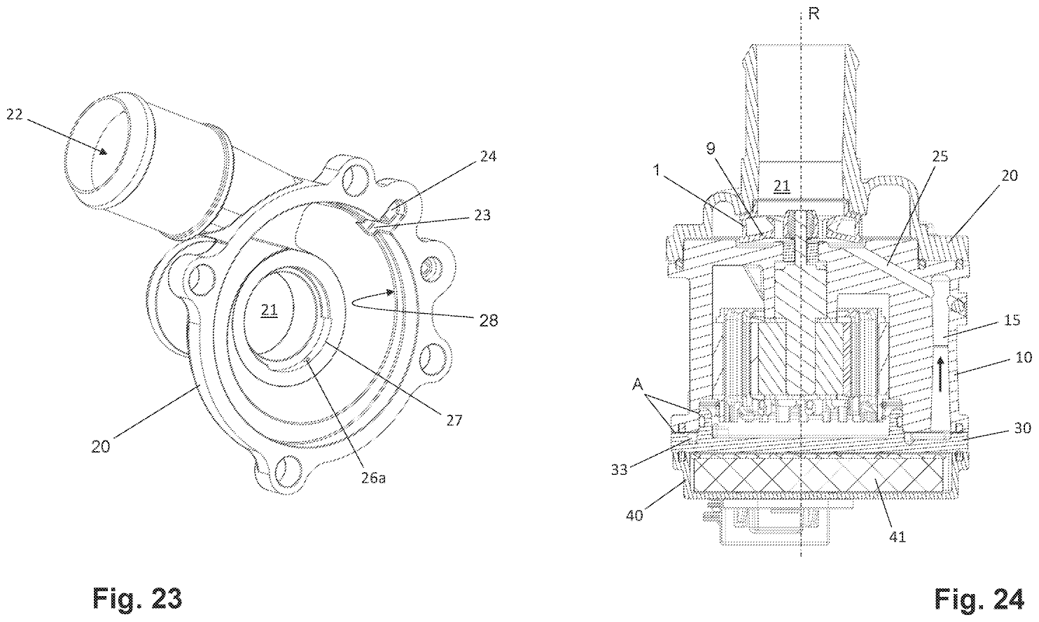

FIG. 23 shows the housing portion 20 of the eighth example embodiment in an isometric view onto the inner side which faces the impeller 1 when the joining structures are joined. The spiral-shaped circumference 28 of the pump space, the divergence opening 23 near the fluid outlet 22, the widening 27 and the channel opening 26a of the connecting channel 25a can again be seen in this isometric view.

FIG. 24 shows the pump-motor unit of the eighth example embodiment in a longitudinal section in which the return channel 15, 25 of the integrated cooling system extends. Unlike the other example embodiments, the fluid which flows back from the cooling channel 33 is not used to compensate for the forces generated by the fluid being delivered. Instead, the fluid which flows back is guided back via the channel portion 25 on the rear side of the impeller 1, below a bearing structure of the impeller 1.

Aside from the differences described, the motor-pump unit corresponds to the first example embodiment, in particular with regard to the cooling structure 30, the joining gap A and the cooling channel 33, such that reference is made to the statements made above. With regard to the pump space, the motor-pump unit corresponds to the seventh example embodiment, aside from the direct connection via the connecting channel 25a, such that reference is made to the seventh example embodiment in relation to the pump space.

### REFERENCE SIGNS

1 impeller
2 paddles
3 covering structure
4 circumferential wall
5 front-facing wall
6 drive shaft
7 stator
8 rotor
9 bearing structure
10 housing portion, motor space portion
11 circumferential wall of the housing
12 front-facing wall of the housing
13 opening
14 feed channel portion
15 return channel portion
16 receptacle
17 sealing element
18 sealing element
19 cooling channel
19a cooling channel inlet
19b cooling channel outlet
20 housing portion, pump space portion
20a dome
20b cover element
21 fluid inlet
22 fluid outlet
23 divergence opening
24 feed channel portion
25 return channel portion
25a return channel
26 return opening
26a channel opening
27 widening
28 spiral-shaped circumference of the housing
29 spiral tongue
30 cooling structure
31 front-facing wall
32 projection, circumferential wall
32a projection, circumferential wall
32b projection, circumferential wall
33 cooling channel
34 cooling channel inlet
35 cooling channel outlet
36 receptacle
37 cooling channel
38 cooling channel
39 -
40 housing portion, electronics space portion
41 electronics component
42 thermally conductive pad
43 connector
A joining gap
B joining gap
C joining gap
R longitudinal axis, rotational axis
α arc angle
β arc angle

1.-15. (canceled)

16. A pump-motor unit comprising:
a housing which features a motor space, an electronics space and a pump space having a fluid inlet and a fluid outlet;
an impeller which is rotatably arranged in the pump space in order to deliver a fluid from the fluid inlet to the fluid outlet;
an electric drive motor which is arranged in the motor space and comprises a stator and a rotatable rotor for rotationally driving the impeller; and
an electronics component which is arranged in the electronics space,
wherein the housing comprises:
a circumferential wall which extends around a longitudinal axis of the housing and surrounds the drive motor;
a cooling structure which is arranged axially between the motor space and the electronics space and joined to the circumferential wall of the housing; and
an annular cooling channel comprising a cooling channel inlet connected to a higher-pressure pump space region and a cooling channel outlet connected to a lower-pressure pump space region, in order to channel some of the fluid from the higher-pressure pump space region to the lower-pressure pump space region via the cooling channel in order to cool the electronics component,
wherein the circumferential wall of the housing forms a joining gap around the longitudinal axis with the cooling structure and
the cooling channel extends and is sealed off around the longitudinal axis in the region of the joining gap.

17. The pump-motor unit according to claim 16, comprising a feed channel, which connects the cooling channel to the higher-pressure pump space region and emerges into the cooling channel inlet, and a return channel which connects the cooling channel to the lower-pressure pump space region and adjoins the cooling channel outlet, wherein the feed channel and the return channel each extend up to the cooling channel peripherally from the drive motor through the circumferential wall of the housing.

18. The pump-motor unit according to claim 16, wherein the cooling channel extends from the cooling channel inlet up to the cooling channel outlet over an angle of at least 270° around the longitudinal axis in the joining gap.

19. The pump-motor unit according to claim 16, wherein the cooling channel extends from the cooling channel inlet up to the cooling channel outlet in one flow direction only.

20. The pump-motor unit according to claim 16, wherein the joining gap comprises a radial joining gap portion and an axial joining gap portion, and a recess in a circumferential wall which delimits the radial joining gap portion or a recess in a front-facing wall of the cooling structure or in the circumferential wall of the housing, the respective wall delimiting the axial joining gap portion, forms the cooling channel, such that the cooling channel extends around the corner into both joining gap portions.

21. The pump-motor unit according to claim 16, wherein a front-facing surface of the circumferential wall of the housing and a front-facing surface of the cooling structure form an annular axial joining gap, and an annular sealing element seals off the axial joining gap around the longitudinal axis on the radially outer side.

22. The pump-motor unit according to claim 16, wherein the cooling structure comprises an axial projection which surrounds the circumferential wall of the housing or is surrounded by the circumferential wall of the housing, wherein the circumferential wall of the housing and the cooling structure radially delimit a radial joining gap which annularly encircles the axial projection and/or the circumferential wall of the housing, and wherein a sealing element seals off the radial joining gap around the longitudinal axis.

23. The pump-motor unit according to claim 16, wherein the impeller is a radial impeller which can be rotated about a rotational axis of the pump and comprises paddles and, on a suction side which faces the fluid inlet, a covering structure which forms a suction-side clearance with the housing.

24. The pump-motor unit according to claim 16, comprising a return channel which connects the cooling channel to the lower-pressure pump space region and terminates in the lower-pressure pump space region at a return opening of the housing which is formed in a clearance which extends around the longitudinal axis and is delimited by the impeller and the housing, wherein the return opening lies opposite the covering structure of the impeller across the clearance, such that the fluid which is guided back into the clearance exerts an axial counterforce on the impeller, counter to an axial force which acts on the impeller due to the fluid being delivered, and/or exerts a radial counterforce on the impeller, counter to a radial force which acts on the impeller due to the fluid being delivered.

25. The pump-motor unit according to claim 24, wherein
the impeller is a radial impeller,
the housing comprises a collecting space having a circumference which extends in a spiral shape around the impeller from a free tongue tip of a spiral tongue, and
the widening, if provided, and/or the return opening is/are distanced from the tongue tip in and counter to the rotational direction of the impeller over an arc angle of more than 60° or more than 90°.

26. The pump-motor unit according to claim 24, wherein the return opening face radially opposite the circumferential wall of the covering structure and/or axially opposite the front-facing wall of the covering structure in the clearance.

27. The pump-motor unit according to claim 16, comprising a return channel which connects the cooling channel to the lower-pressure pump space region and terminates in the lower-pressure pump space region at a return opening of the housing which is formed in a clearance which is delimited by the impeller and the housing, wherein the housing comprises a widening in the region of the clearance, wherein the widening extends in the circumferential direction over an arc angle of at least 20° and at most 120° around the impeller and radially and/or axially widens the clearance.

28. The pump-motor unit according to claim 27, wherein
the impeller is a radial impeller,
the housing comprises a collecting space having a circumference which extends in a spiral shape around the impeller from a free tongue tip of a spiral tongue, and
the widening, if provided, and/or the return opening is/are distanced from the tongue tip in and counter to the rotational direction of the impeller over an arc.

29. The pump-motor unit according to claim 27, wherein the widening and/or the return opening face radially opposite the circumferential wall of the covering structure and/or axially opposite the front-facing wall of the covering structure in the clearance.

30. The pump-motor unit according to claim 16, wherein
the impeller is a radial impeller,
the housing comprises a collecting space having a circumference which extends in a spiral shape around the impeller from a free tongue tip of a spiral tongue,
the cooling channel is connected to the higher-pressure pump space region via a feed channel, and
the feed channel emerges at a divergence opening on the spiral-shaped circumference of the collecting space in the higher-pressure pump space region.

31. The pump-motor unit according to claim 16, wherein the circumferential wall of the housing comprises a motor space opening on the front-facing side, and the cooling structure forms a motor space cover which closes off the motor space opening and separates the electronics space from the motor space.

32. The pump-motor unit according to claim 16, wherein the circumferential wall of the housing surrounds the motor space and the cooling structure and protrudes beyond the cooling structure in both axial directions, and wherein an inner circumference of the circumferential wall of the housing and an outer circumference of the cooling structure lie opposite each other, forming a radial joining gap in which the cooling channel is formed, wherein the circumferential wall of the housing preferably also surrounds the electronics space.

33. The pump-motor unit according to claim 21, wherein the annular sealing element is a sealing ring which acts as an axial gasket.

34. The pump-motor unit according to claim 22, wherein the sealing element is a sealing ring which acts as a radial gasket.

35. The pump-motor unit according to claim 16, wherein the pump-motor unit is arranged to deliver a water-based cooling liquid of a motor vehicle.
